(19) United States
(12) Patent Application Publication
(10) Pub. No.: US 2024/0114903 A1
(43) Pub. Date: Apr. 11, 2024

(54) SYNERGISTIC MIXTURES COMPRISING PYRETHRUM FOR ARTHROPOD TOXICITY AND REPELLENCY

(71) Applicant: University of Florida Research Foundation, Incorporated, Gainesville, FL (US)

(72) Inventors: Jeffrey R. Bloomquist, Gainesville, FL (US); Edmund J. Norris, Gainesville, FL (US)

(21) Appl. No.: 18/271,769

(22) PCT Filed: Jan. 28, 2022
(86) PCT No.: PCT/US2022/014386

§ 371 Date: Jul. 11, 2023

Related U.S. Application Data
(60) Provisional application No. 63/143,581, filed on Jan. 29, 2021.

(51) Int. Cl. A01N 37/08; A01N 25/04; A01N 65/06; A01N 65/08; A01N 65/10; A01N 65/28; A01N 65/36; A01N 65/44; A01N 65/48; A01P 7/04; A01P 17/00

(52) U.S. Cl. CPC A01N 37/08; A01N 25/04; A01N 65/06; A01N 65/08; A01N 65/10; A01N 65/28; A01N 65/36; A01N 65/44; A01N 65/48; A01P 7/04; A01P 17/00

(57) ABSTRACT

The subject matter described herein is directed to synergistic compositions comprising pyrethrum vapor and a second agent selected from the group consisting of an essential oil and a compound of Formula I. In other embodiments, topical synergistic compositions comprising pyrethrum and an essential oil are described. Additionally described are methods for repelling and controlling arthropods using the synergistic compositions.

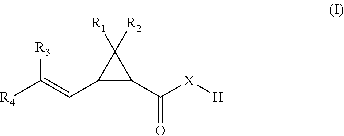

### CROSS REFERENCE TO RELATED APPLICATIONS

This application claims the benefit of and priority to U.S. Provisional Application No. 63/143,581, filed on Jan. 29, 2021, the contents of which are incorporated herein by reference.

### GOVERNMENT INTEREST

This invention was made with government support under the CDC Grant 1U01CK000510: Southeastern Regional Center of Excellence in Vector-Borne Diseases: The Gateway Program. The government has certain rights in the invention.

### FIELD

The subject matter described herein is directed to arthropod repellent synergistic compositions and methods for using the compositions to control arthropods.

### BACKGROUND

Biting insects are a nuisance and are also known to be carriers of disease. Compositions that repel insects, particularly insect pests such as mosquitoes, flies, and fleas, are widely used to prevent animals from being bitten by such insects. The importance of preventing biting is essentially two-fold. Firstly, there are a number of insects capable of infecting animals with disease causing parasites, an example being the transmission of Plasmodium falciparum: by mosquitoes to cause malaria. Secondly, in many cases whether disease is transmitted or not, the bite can be extremely irritating.

Insect repellents that act to repel insects from surfaces, including the skin of animals, are commercially available. They are designed to reduce or prevent the tendency of the insect to contact the surface, thereby preventing the biting. Over the years, a number of different oils, greases, ointments, sprays, and powders have been employed as insect repellents with varying degrees of success. Other delivery methods, such as fans, heated emanators, and burning coils, have also been developed with the purpose of repelling insects. Oil of citronella was reported to be an effective insect repellent as early as 1901. Another natural product, nicotine from tobacco, was used as a repellent as long ago as 1760. Since World War II, a number of synthetic insect repellents have been introduced.

One such repellent is N,N-diethyl-m-toluamide (DEET). It is a synthetic insect repellent that has demonstrated superior insect repellency in comparison to other repellents, including natural insect repellents. However, there is concern that repeated DEET exposure may have harmful consequences. For example, possible DEET side effects are irritability, confusion, insomnia, and even seizures. For these reasons, caution is generally recommended with regard to the use of DEET as an insect repellent. This is especially true when DEET is applied to children, who are more susceptible to the potentially injurious effects of exposure to DEET.

Pyrethrin esters (Pyrethrins I and Pyrethrins II) are a group of naturally occurring organic compounds contained in some perennial plants, such as chrysanthemums (e.g., Chrysanthemum cinerariaefolium) and are active ingredients in the widely-used pyrethrum extract. Pyrethrin I and Pyrethrin II are compositions of structurally related pyrethrin esters that all contain a cyclopropane core Combinations of pyrethrins I and pyrethrins II are sometimes referred to as “pyrethrins”; individual pyrethrin esters are referred to as “a pyrethrin”; and compositions containing pyrethrins are often referred to as “pyrethrum.” Pyrethrins have been used as an insecticide for many years. Pyrethrins act as neurotoxins against insects and can provide immediate knockdown of flying insects even when present in amounts that are not lethal to insects. These compounds are biodegradable and are inactivated by oxidation or exposure to light. Because pyrethrins have a very low toxicity in mammals and are biodegradable (leaving little to no residue in the environment) they represent an attractive alternative to other classes of insecticidal compounds, such as organophosphates and organochlorides, which are associated with greater regulatory scrutiny and have a more significant impact on the environment. Accordingly, pyrethrins are used in a wide variety of applications, including formulations for indoor and outdoor use, to such an extent that there are approximately 1,350 end-use products containing pyrethrins registered with the United States Environmental Protection Agency (EPA) for use in agricultural, commercial, residential, and public health applications [Pyrethrin Reregistration Eligibility Decision, EPA 2006].

While pyrethrins have potent insecticidal and knockdown activity, they are susceptible to detoxification mechanisms. Also, fast and efficient insect knockdown does not necessarily lead to insect death, as insects can recover after the initial knockdown. Also desirable are insect repellents that do not need to be re-applied frequently. For economic and safety reasons, it would be beneficial to be able to use the least amount of active agents that provide the desired efficacy. The same is true for spatial repellents, vapor-active and deployed to keep a room, house, or tent, free of biting insects. Therefore, what is needed are alternative compositions comprising natural pyrethrins, such as synergistic compositions, that retain insecticidal and knockdown potency whereby the concentrations and amounts of compounds required for efficacy are lessened. The subject matter described herein addresses the shortcomings of the art.

### BRIEF SUMMARY

In one aspect, the subject matter disclosed herein is directed to an arthropod control composition comprising pyrethrum; and a second agent selected from the group consisting of:
i. a compound of Formula I

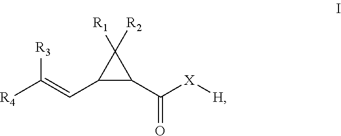

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
   wherein said composition is synergistic, in admixture with a carrier.

In another aspect, the subject matter disclosed herein is directed to a method of providing a composition described herein in an arthropod repellent medium from which the vaporized composition can be dispersed.

In another aspect, the subject matter disclosed herein is directed to a method of repelling an arthropod from an object or locus, comprising contacting said object or locus with a composition comprising pyrethrum; and a second agent selected from the group consisting of:
i. a compound of Formula I

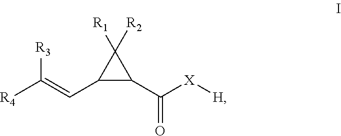

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
   wherein,
said composition is synergistic, in admixture with a carrier; and,
said arthropod is repelled from an adjacent area to said object or locus and is not physically in contact with said object or locus.

In another aspect, the subject matter described herein is directed to a method for controlling one or more arthropods, comprising contacting an object or locus adjacent to said one or more arthropods with a composition comprising pyrethrum and a second agent selected from the group consisting of:
i. a compound of Formula I

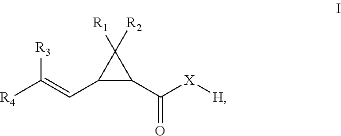

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
   wherein,
said composition is synergistic, in admixture with a carrier; and,
said one or more arthropods are not physically in contact with said object or locus.

Other aspects are also described.

### BRIEF DESCRIPTION OF THE DRAWINGS

FIG. 1 shows a graph demonstrating how the 24 hour mortality % of natural pyrethrum vapor (μg/cm²) is synergized by the addition of 1R-trans-chrysanthemic acid (TCA) or (1R,3S)-3-(2,2-dichloroethenyl)-2,2-dimethylcyclopropanecarboxylic acid (TFA). Symbols are means±SEM.

FIG. 2 shows a graph demonstrating how the 24 hour mortality % of natural pyrethrum vapor (μg/cm²) is synergized by the addition of citronella oil. Symbols are means±SEM.

FIG. 3 shows a graph demonstrating how the 24 hour mortality % of natural pyrethrum vapor (μg/cm²) is synergized by the addition of various plant essential oils, geranium, CWV, Amyris, and clove leaf oil. Symbols are means and SEM bars are omitted for clarity.

FIG. 4 shows the repellency proportion of pyrethrum after 1 hr of exposure at 100 μg/cm² measured as a proportion of mosquitoes on the chemically-treated side.

FIG. 5 shows Synergism ratios of LD₅₀ values (SR) plotted against co-toxicity factors (CTF) obtained at (A) 2 μg/insect and (B) 10 μg/insect, along with linear regression analysis. Strong linear correlation value was observed for the 2 μg/insect (Pearson's correlation coefficient r=0.94), whereas at 10 μg/insect moderate linear correlation was observed (Pearson's correlation coefficient r=0.64).

### DETAILED DESCRIPTION

Described herein are synergistic arthropod control compositions comprising pyrethrum and a second agent, wherein the second agent is a compound of Formula I or an essential oil. Additionally described are methods of using the synergistic compositions to repel arthropods.

Pyrethroids typically contain ester linkages. Carboxylesterase hydrolysis of pyrethroids is considered a detoxication reaction that will produce a pyrethroid acid and alcohol. Although pyrethroids such as transfluthrin and metofluthrin are often utilized in commercial repellents, it was generally accepted that the acids of these pyrethroids were devoid of any biological activity, including repellency or toxicity. Without wishing to be bound by theory, it is understood that resistant strains of insects can have up-regulated esterases as a mechanism of resistance, although binding to the esterase regardless of whether any hydrolysis occurs may be a contributing factor (K Wang, Y Huang, X Li, and M Chen, Functional Analysis of a Carboxylesterase Gene Associated With Isoprocarb and Cyhalothrin Resistance in Rhopalosiphum padi (L.). Frontiers in Physiology 9:992, 2018). As described herein, however, it has been found that pyrethroid acids unexpectedly have repellent bioactivy in synergistic compositions with pyrethrum. As such, the subject matter described herein is directed to methods of repelling and controlling arthropods using compositions comprising acids of pyrethroid compounds (compounds of Formula I).

Additionally described are synergistic compositions comprising pyrethrum and an essential oil. Surprisingly, the essential oils are able to synergize pyrethrum and demonstrate increased vapor and topical toxicity, even at low concentrations.

Indeed, plant essential oils are now recognized as effective alternatives to synthetic insecticides against a wide variety of pests. Their generally pleasant aroma, relatively low toxicity to humans and pets, and perceived salubrious qualities have given rise to a large increase in research focused on the development of these agents for pest control (Isman, M. B.; Grieneisen, M. L. Botanical insecticide research: Many publications, limited useful data. Trends Plant. Sci. 2014, 19, 140-145).

Components in essential oil-based insecticide formulations are considered “generally recognized as safe” (GRAS) by the United States Environmental Protection Agency, under the Federal Insecticide, Fungicide, and Rodenticide Act (FIFRA) (Miresmailli, S.; Isman, M. B. Botanical insecticides inspired by plant-herbivore chemical interactions. Trends Plant. Sci. 2014, 19, 29-35. These components are listed in the 25b Exempt category under FIFRA code due to their usage throughout human history, and because they are found in many household food items and fragrances (Miresmailli, S.; Isman, M. B. Botanical insecticides inspired by plant-herbivore chemical interactions. Trends Plant. Sci. 2014, 19, 29-35; and Qualls, W. A, et al. Evaluation of Lotions of Botanical-Based Repellents Against Aedes aegypti (Diptera: Culicidae). J. Med. Entomol. 2020). Reclassification of certain components has relaxed the regulatory re-quirements for registration of plant essential oil-based insecticides and repellents, and allowed for the rapid diversification of novel products. Coupled with the recent consumer-driven push for more natural and “green” control strategies, more of these products are now available for purchase than ever before (Isman, M. B. A renaissance for botanical insecticides? Pest. Manag. Sci. 2015, 71, 1587-1590; and Qualls, W. A., et al. Evaluation of Lotions of Botanical-Based Repellents Against Aedes aegypti (Diptera: Culicidae). J. Med. Entomol. 2020). Moreover, many oils have been shown to produce potent synergism with various synthetic insecticides, further demonstrating their utility. Gross et al. demonstrated that various plant essential oils could enhance the toxicity of permethrin against adult female Aedes aegypti and Anopheles gambiae (Gross, A. D, et al. Essential oils enhance the toxicity of permethrin against Aedes aegypti and Anopheles gambiae. Med. Vet. Entomol. 2017, 31, 55-62). Furthermore, Norris et al. showed that the most successful plant oils in the Gross et al. 2015 study could synergize structurally diverse type I and type II pyrethroids, further indicating their activity as synergists (Norris, E. J., et al, Comparison of the Insecticidal Characteristics of Commercially Available Plant Essential Oils Against Aedes aegypti and Anopheles gambiae (Diptera: Culicidae). J. Med. Entomol. 2015, 52, 993-1002). It is important to continually identify novel synergists and toxic additives that could be combined with synthetic insecticides in future insecticidal formulations.

The presently disclosed subject matter will now be described more fully hereinafter. However, many modifications and other embodiments of the presently disclosed subject matter set forth herein will come to mind to one skilled in the art to which the presently disclosed subject matter pertains having the benefit of the teachings presented in the foregoing descriptions. Therefore, it is to be understood that the presently disclosed subject matter is not to be limited to the specific embodiments disclosed and that modifications and other embodiments are intended to be included within the scope of the appended claims. In other words, the subject matter described herein covers all alternatives, modifications, and equivalents. In the event that one or more of the incorporated literature, patents, and similar materials differs from or contradicts this application, including but not limited to defined terms, term usage, described techniques, or the like, this application controls. Unless otherwise defined, all technical and scientific terms used herein have the same meaning as commonly understood by one of ordinary skill in this field. All publications, patent applications, patents, and other references mentioned herein are incorporated by reference in their entirety.

### I. Definitions

As used in the present specification, the following words, phrases and symbols are generally intended to have the meanings as set forth below, except to the extent that the context in which they are used indicates otherwise.

A dash (“-”) that is not between two letters or symbols is used to indicate a point of attachment for a substituent. For example, —C(O)NH₂ is attached through the carbon atom. A dash at the front or end of a chemical group is a matter of convenience; chemical groups may be depicted with or without one or more dashes without losing their ordinary meaning. A wavy line or a dashed line drawn through or perpendicular across the end of a line in a structure indicates a specified point of attachment of a group. Unless chemically or structurally required, no directionality or stereochemistry is indicated or implied by the order in which a chemical group is written or named.

The prefix “Cᵤ-Cᵥ” indicates that the following group has from u to v carbon atoms. For example, “C₁-C₆ alkyl” indicates that the alkyl group has from 1 to 6 carbon atoms.

Reference to “about” a value or parameter herein includes (and describes) embodiments that are directed to that value or parameter per se. In certain embodiments, the term “about” includes the indicated amount ±50%. In certain other embodiments, the term “about” includes the indicated amount ±20%. In certain other embodiments, the term “about” includes the indicated amount ±10%. In other embodiments, the term “about” includes the indicated amount ±5%. In certain other embodiments, the term “about” includes the indicated amount ±1%. In certain other embodiments, the term “about” includes the indicated amount ±0.5% and in certain other embodiments, 0.1%. Such variations are appropriate to perform the disclosed methods or employ the disclosed compositions. Also, to the term “about x” includes description of “x”. Also, the singular forms “a” and “the” include plural references unless the context clearly dictates otherwise. Thus, e.g., reference to “the compound” includes a plurality of such compounds and reference to “the assay” includes reference to one or more assays and equivalents thereof known to those skilled in the art.

“Alkyl” refers to an unbranched or branched saturated hydrocarbon chain. As used herein, alkyl has 1 to 20 carbon atoms (i.e., C₁-C₂₀ alkyl), 1 to 12 carbon atoms (i.e., C₁-C₁₂ alkyl), 1 to 8 carbon atoms (i.e., C₁-C₈ alkyl), 1 to 6 carbon atoms (i.e., C₁-C₆ alkyl), 1 to 4 carbon atoms (i.e., C₁-C₄ alkyl), 5 to 12 carbon atoms (i.e., C₅-C₁₂), or 1 to 3 carbon atoms (i.e., C₁-C₃ alkyl). Examples of alkyl groups include, e.g., methyl, ethyl, propyl, isopropyl, n-butyl, sec-butyl, iso-butyl, tert-butyl, pentyl, 2-pentyl, isopentyl, neopentyl, hexyl, 2-hexyl, 3-hexyl and 3-methylpentyl. When an alkyl residue having a specific number of carbons is named by chemical name or identified by molecular formula, all positional isomers having that number of carbons may be encompassed; thus, for example, “butyl” includes n-butyl (i.e., —(CH₂)₃CH₃), sec-butyl (i.e., —CH(CH₃)CH₂CH₃), isobutyl (i.e., —CH₂CH(CH₃)₂) and tert-butyl (i.e., —C(CH₃)₃); and “propyl” includes n-propyl (i.e., —(CH₂)₂CH₃) and isopropyl (i.e., —CH(CH₃)₂).

Certain commonly used alternative chemical names may be used. For example, a divalent group such as a divalent “alkyl” group, a divalent “aryl” group, etc., may also be referred to as an “alkylene” group or an “alkylenyl” group, an “arylene” group or an “arylenyl” group, respectively. Also, unless indicated explicitly otherwise, where combinations of groups are referred to herein as one moiety, e.g., arylalkyl or aralkyl, the last mentioned group contains the atom by which the moiety is attached to the rest of the molecule.

“Alkoxy” refers to the group “alkyl-O—”. Examples of alkoxy groups include, e.g., methoxy, ethoxy, n-propoxy, iso-propoxy, n-butoxy, tert-butoxy, sec-butoxy, n-pentoxy, n-hexoxy and 1,2-dimethylbutoxy.

“Amino” refers to the group —NR^{y}R^{z} wherein R^{y} and R^{z} are independently hydrogen, alkyl, alkenyl, alkynyl, cycloalkyl, heterocyclyl, aryl, heteroalkyl or heteroaryl; each of which may be optionally substituted, as defined herein.

“Aryl” refers to an aromatic carbocyclic group having a single ring (e.g., monocyclic) or multiple rings (e.g., bicyclic or tricyclic) including fused systems. As used herein, aryl has 6 to 20 ring carbon atoms (i.e., C₆-C₂₀ aryl), 6 to 12 carbon ring atoms (i.e., C₆-C₁₂ aryl), or 6 to 10 carbon ring atoms (i.e., C₆-C₁₀ aryl). Examples of aryl groups include, e.g., phenyl, naphthyl, fluorenyl and anthryl. Aryl, however, does not encompass or overlap in any way with heteroaryl defined below. If one or more aryl groups are fused with a heteroaryl, the resulting ring system is heteroaryl. If one or more aryl groups are fused with a heterocyclyl, the resulting ring system is heterocyclyl.

“Arylhalo” refers to an aryl that is substituted with one or more halo substituents. In certain embodiments, the arylhalo may be substituted with 1, 2, 3, 4, 5, or 6 halo substituents.

“Arylalkyl” or “Aralkyl” refers to the group “aryl-alkyl-”, such as benzyl.

“Cycloalkyl” refers to a saturated or partially unsaturated cyclic alkyl group having a single ring or multiple rings including fused, bridged and spiro ring systems. The term “cycloalkyl” includes cycloalkenyl groups (i.e., the cyclic group having at least one double bond) and carbocyclic fused ring systems having at least one sp³ carbon atom (i.e., at least one non-aromatic ring). As used herein, cycloalkyl has from 3 to 20 ring carbon atoms (i.e., C₃-C₂₀ cycloalkyl), 3 to 12 ring carbon atoms (i.e., C₃-C₁₂ cycloalkyl), 3 to 10 ring carbon atoms (i.e., C₃-C₁₀ cycloalkyl), 3 to 8 ring carbon atoms (i.e., C₃-C₈ cycloalkyl), 3 to 7 ring carbon atoms (i.e., C₃-C₇ cycloalkyl), or 3 to 6 ring carbon atoms (i.e., C₃-C₆ cycloalkyl). Monocyclic groups include, for example, cyclopropyl, cyclobutyl, cyclopentyl, cyclohexyl, cycloheptyl and cyclooctyl. Polycyclic groups include, for example, bicyclo[2.2.1]heptanyl, bicyclo[2.2.2]octanyl, adamantyl, norbornyl, decalinyl, 7,7-dimethyl-bicyclo[2.2.1]heptanyl and the like. Further, the term cycloalkyl is intended to encompass any non-aromatic ring which may be fused to an aryl ring, regardless of the attachment to the remainder of the molecule. Still further, cycloalkyl also includes “spirocycloalkyl” when there are two positions for substitution on the same carbon atom, for example spiro[2.5]octanyl, spiro[4.5]decanyl, or spiro[5.5]undecanyl.

“Alkyl-alkoxy” refers to the group “-alkyl-alkoxy.”

“Cycloalkylalkyl” refers to the group “cycloalkyl-alkyl-”.

“Halogen” or “halo” refers to atoms occupying group VIIA of the periodic table, such as fluoro, chloro, bromo or iodo.

“Haloalkyl” refers to an unbranched or branched alkyl group as defined above, wherein one or more (e.g., 1 to 6, or 1 to 3) hydrogen atoms are replaced by a halogen. For example, where a residue is substituted with more than one halogen, it may be referred to by using a prefix corresponding to the number of halogen moieties attached. Dihaloalkyl and trihaloalkyl refer to alkyl substituted with two (“di”) or three (“tri”) halo groups, which may be, but are not necessarily, the same halogen. Examples of haloalkyl include, e.g., trifluoromethyl, difluoromethyl, fluoromethyl, trichloromethyl, 2,2,2-trifluoroethyl, 1,2-difluoroethyl, 3-bromo-2-fluoropropyl, 1,2-dibromoethyl and the like.

“Haloalkoxy” refers to an alkoxy group as defined above, wherein one or more (e.g., 1 to 6, or 1 to 3) hydrogen atoms are replaced by a halogen.

“Hydroxyalkyl” refers to an alkyl group as defined above, wherein one or more (e.g., 1 to 6, or 1 to 3) hydrogen atoms are replaced by a hydroxy group.

“Heteroaryl” refers to an aromatic group having a single ring, multiple rings or multiple fused rings, with one or more ring heteroatoms independently selected from nitrogen, oxygen, and sulfur. As used herein, heteroaryl includes 1 to 20 ring carbon atoms (i.e., C₁-C₂₀ heteroaryl), 3 to 12 ring carbon atoms (i.e., C₃-C₁₂ heteroaryl), or 3 to 8 carbon ring atoms (i.e., C₃-C₈ heteroaryl), and 1 to 5 ring heteroatoms, 1 to 4 ring heteroatoms, 1 to 3 ring heteroatoms, 1 to 2 ring heteroatoms, or 1 ring heteroatom independently selected from nitrogen, oxygen and sulfur. In certain instances, heteroaryl includes 9-10 membered ring systems, 5-10 membered ring systems, 5-7 membered ring systems, or 5-6 membered ring systems, each independently having 1 to 4 ring heteroatoms, 1 to 3 ring heteroatoms, 1 to 2 ring heteroatoms, or 1 ring heteroatom independently selected from nitrogen, oxygen and sulfur. Examples of heteroaryl groups include, e.g., acridinyl, benzimidazolyl, benzothiazolyl, benzindolyl, benzofuranyl, benzothiazolyl, benzothiadiazolyl, benzonaphthofuranyl, benzoxazolyl, benzothienyl (benzothiophenyl), benzotriazolyl, benzo[4,6]imidazo[1,2-a]pyridyl, carbazolyl, cinnolinyl, dibenzofuranyl, dibenzothiophenyl, furanyl, isothiazolyl, imidazolyl, indazolyl, indolyl, indazolyl, isoindolyl, isoquinolyl, isoxazolyl, naphthyridinyl, oxadiazolyl, oxazolyl, 1-oxidopyridinyl, 1-oxidopyrimidinyl, 1-oxidopyrazinyl, 1-oxidopyridazinyl, phenazinyl, phthalazinyl, phthalimidyl, pteridinyl, purinyl, pyrrolyl, pyrazolyl, pyridinyl, pyrazinyl, pyrimidinyl, pyridazinyl, quinazolinyl, quinoxalinyl, quinolinyl, quinuclidinyl, isoquinolinyl, thiazolyl, thiadiazolyl, triazolyl, tetrazolyl and triazinyl. Examples of the fused-heteroaryl rings include, but are not limited to, benzo[d]thiazolyl, quinolinyl, isoquinolinyl, benzo[b]thiophenyl, indazolyl, benzo[d]imidazolyl, pyrazolo[1,5-a]pyridinyl and imidazo[1,5-a]pyridinyl, where the heteroaryl can be bound via either ring of the fused system. Any aromatic ring, having a single or multiple fused rings, containing at least one heteroatom, is considered a heteroaryl regardless of the attachment to the remainder of the molecule (i.e., through any one of the fused rings). Heteroaryl does not encompass or overlap with aryl as defined above.

“Heteroarylalkyl” refers to the group “heteroaryl-alkyl-”.

“Heterocyclyl” refers to a saturated or partially unsaturated cyclic alkyl group, with one or more ring heteroatoms independently selected from nitrogen, oxygen and sulfur. The term “heterocyclyl” includes heterocycloalkenyl groups (i.e., the heterocyclyl group having at least one double bond), bridged-heterocyclyl groups, fused-heterocyclyl groups and spiro-heterocyclyl groups. A heterocyclyl may be a single ring or multiple rings wherein the multiple rings may be fused, bridged or spiro, and may comprise one or more (e.g., 1 to 3) oxo (═O) or N-oxide (—O⁻) moieties. Any non-aromatic ring containing at least one heteroatom is considered a heterocyclyl, regardless of the attachment (i.e., can be bound through a carbon atom or a heteroatom). Further, the term heterocyclyl is intended to encompass any non-aromatic ring containing at least one heteroatom, which ring may be fused to an aryl or heteroaryl ring, regardless of the attachment to the remainder of the molecule. As used herein, heterocyclyl has 2 to 20 ring carbon atoms (i.e., C₂-C₂₀ heterocyclyl), 2 to 12 ring carbon atoms (i.e., C₂-C₁₂ heterocyclyl), 2 to 10 ring carbon atoms (i.e., C₂-C₁₀ heterocyclyl), 2 to 8 ring carbon atoms (i.e., C₂-C₅ heterocyclyl), 3 to 12 ring carbon atoms (i.e., C₃-C₁₂ heterocyclyl), 3 to 8 ring carbon atoms (i.e., C₃-C₈ heterocyclyl), or 3 to 6 ring carbon atoms (i.e., C₃-C₆ heterocyclyl); having 1 to 5 ring heteroatoms, 1 to 4 ring heteroatoms, 1 to 3 ring heteroatoms, 1 to 2 ring heteroatoms, or 1 ring heteroatom independently selected from nitrogen, sulfur or oxygen. When the heterocycle ring contains 4- or 6-ring atoms, it is also referred to herein as a 4- or 6-membered heterocycle. Examples of heterocyclyl groups include, e.g., azetidinyl, azepinyl, benzodioxolyl, benzo[b][1,4]dioxepinyl, 1,4-benzodioxanyl, benzopyranyl, benzodioxinyl, benzopyranonyl, benzofuranonyl, dioxolanyl, dihydropyranyl, hydropyranyl, thienyl[1,3]dithianyl, decahydroisoquinolyl, furanonyl, imidazolinyl, imidazolidinyl, indolinyl, indolizinyl, isoindolinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, oxiranyl, oxetanyl, phenothiazinyl, phenoxazinyl, piperidinyl, piperazinyl, 4-piperidonyl, pyrrolidinyl, pyrazolidinyl, quinuclidinyl, thiazolidinyl, tetrahydrofuryl, tetrahydropyranyl, trithianyl, tetrahydroquinolinyl, thiophenyl (i.e., thienyl), tetrahydropyranyl, thiomorpholinyl, thiamorpholinyl, 1-oxo-thiomorpholinyl and 1,1-dioxo-thiomorpholinyl. The term “heterocyclyl” also includes “spiroheterocyclyl” when there are two positions for substitution on the same carbon atom. Examples of the spiro-heterocyclyl rings include, e.g., bicyclic and tricyclic ring systems, such as 2-oxa-7-azaspiro[3.5]nonanyl, 2-oxa-6-azaspiro[3.4]octanyl and 6-oxa-1-azaspiro[3.3]heptanyl. Examples of the fused-heterocyclyl rings include, but are not limited to, 1,2,3,4-tetrahydroisoquinolinyl, 4,5,6,7-tetrahydrothieno[2,3-c]pyridinyl, indolinyl and isoindolinyl, where the heterocyclyl can be bound via either ring of the fused system.

“Heterocyclylalkyl” refers to the group “heterocyclyl-alkyl-.”

The compounds of the presently claimed subject matter, or their agrochemically acceptable salts include an asymmetric center and may thus give rise to enantiomers, diastereomers, and other stereoisomeric forms that may be defined, in terms of absolute stereochemistry, as (R)- or (S)- or, as (D)- or (L)- for amino acids. The presently claimed subject matter is meant to include all such possible isomers, as well as their racemic, optically pure, and enantiomerically/diastereomerically enriched forms. Optically active (+) and (−), (R)- and (S)-, or (D)- and (L)-isomers may be prepared using chiral synthons or chiral reagents, or resolved using conventional techniques, for example, chromatography and fractional crystallization. Conventional techniques for the preparation/solation of individual enantiomers include chiral synthesis from a suitable optically pure precursor or resolution of the racemate (or the racemate of a salt or derivative) using, for example, chiral high pressure liquid chromatography (HPLC). When the compounds described herein contain olefinic double bonds or other centres of geometric asymmetry, and unless specified otherwise, it is intended that the compounds include both E and Z geometric isomers.

A “stereoisomer” refers to a compound made up of the same atoms bonded by the same bonds but having different three-dimensional structures, which are not interchangeable. The present invention contemplates various stereoisomers and mixtures thereof and includes “enantiomers,” which refers to two stereoisomers whose molecules are nonsuperimposeable mirror images of one another.

“Diastereomers” are stereoisomers that have at least two asymmetric atoms, but which are not mirror-images of each other.

Relative centers of the compounds as depicted herein are indicated graphically using the “thick bond” style (bold or parallel lines) and absolute stereochemistry is depicted using wedge bonds (bold or parallel lines).

As used herein, “OR” refers to the Orlando insecticide-susceptible strain of Ae. aegypti.

As used herein, “PR” refers to the pyrethroid-resistant Puerto Rico (PR) strain of Ae. aegypti.

As used herein, “pyrethrum,” or “natural pyrethrins” refers to a botanical mixture of naturally derived insecticides commonly used in insect control. It is a mixture of six closely related chemical forms extracted from the Chrysanthemum plant (Pyrethrin I, Cinerin I, Jasmolin I, Pyrethrin II, Cinerin II, and Jasmolin II). Conversely, pyrethroids are individual synthetically produced insecticides.

“Synergistic” as used herein refers to a combination which is more effective than the additive effects of the two or more single agents alone. A determination of a synergistic interaction between two active compounds may, in some embodiments, be based on the results obtained from the experimental information described herein. The results of these experiments can be analyzed using, for example, the Bliss activity method, co-toxicity factors (CF), or synergism ratios, described further herein.

As used herein, “controlling one or more insects” or “controlling one or more arthropods” refers to mitigating or reducing a population of insects or a population of arthropods, respectively. As used herein, “arthropod control composition” refers to a composition that exhibits a controlling effect (knockdown effect, repellent effect, mortality, etc.). Knockdown, as used herein, refers to a quick, short-term immobilization, or death, of the arthropod. In certain other embodiments, knockdown is defined as a mosquito's inability to fly or maintain normal standing posture for a set period of time. In certain embodiments described herein, the arthropods, or mosquitos, experience knockdown within a certain amount of time of exposure to an arthropod control composition, meaning that the arthropod's exposure to the composition results in the arthropod's inability to maintain short-term normal standing posture and/or initiate flight (immobilization). In certain embodiments, mortality is defined as a mosquito exhibiting no movement after a set period of time (i.e., death). In certain embodiments described herein, the arthropods, or mosquitos, reach their mortality within a certain amount of time of exposure to an arthropod control composition, meaning that the arthropod's exposure to the composition results in the arthropod's inability to move for an extended period of time, because it has died. Death is typically confirmed by probing the mosquito and failing to receive a response.

As used herein, “contacting” refers to contacting a synergistic composition disclosed herein with an arthropod or a locus. In certain embodiments, such contacting can be achieved by applying a composition to the pronotum of a mosquito by means of a syringe. This is referred to as topical contact. In other embodiments, the synergistic compositions described herein are vapor active and achieve vapor toxicity by the vapor phase (i.e. by acting as a spatial arthropod repellent).

As used herein, the unit, “μg/cm²” refers to an active ingredient (i.e. an essential oil) per unit area. The unit, “μg/cm²” is typically used to denote the concentrations of vapor-active (spatial) repellents.

As used herein, the unit, “ug/insect” refers to a dose of an active ingredient, such as an essential oil, directly applied to an insect. The unit, “ug/insect” typically refers to a concentration of active ingredient that is topically applied to an insect.

Additional definitions may also be provided below as appropriate.

### II. Compounds

In certain embodiments, the subject matter described herein is directed to compounds of Formula I:

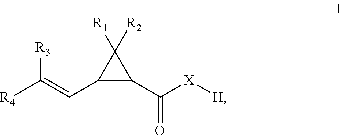

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S.

In certain embodiments, useful compounds of Formula I include those where X is O.

In certain embodiments, useful compounds of Formula I include those where R₁ and R₂ are each methyl.

In certain embodiments, useful compounds of Formula I include those where R₃ and R₄ are each independently selected from the group consisting of C₁₋C₃ alkyl and halo.

In certain embodiments, useful compounds of Formula I include those where R₃ and R₄ are each independently methyl.

In certain embodiments, useful compounds of Formula I include those having the structure

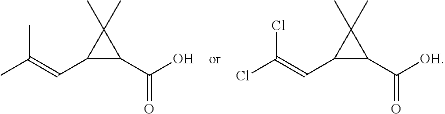

### III. Compositions

The arthropod control or arthropod repellent compositions described herein may take various forms, including solutions, dusts, granular formulations, and emulsions. They may be prepared from concentrates, such as emulsifiable concentrates and wettable powders. In addition to the active agents, the compositions can also comprise various inert ingredients, depending upon the form taken by the composition.

If prepared from an emulsifiable concentrate, the composition may contain a surfactant such as, for example, a mixture of a polyethylene oxide with a blend of oil soluble non-ionic and anionic sulfonates. The surfactant normally comprises between about 1 and 15% by weight of the emulsifiable concentrate.

Wettable powders can also be used to make the repellent compositions. Compositions so made may be applied to the area to be protected as emulsions in water or other liquid diluents. Typical among the carriers employed in wettable powders are walnut flour, cane sugar, fuller's earth, attapulgite clays, kaolin clays, silicas and other highly absorbent, readily wetted carriers. The wettable powders themselves generally are prepared to contain about 5 to 80% by weight of the active component, depending on the absorbency of the carrier. A wettable powder usually also contains a small amount of a surfactant.

Granular repellent compositions, wherein the active component is carried on relatively coarse particles as the carrier, are also useful in repelling crawling insect pests. Dry dusts, in which the active component is admixed with finely divided solids such as talc, attapulgite clay, kieselguhr, and other organic and inorganic solids, which act as carriers for the active component, also find utility. These finely divided solids usually have an average particle size of less than about 50 microns.

Pressurized sprays such as aerosols, in which the active component is present in solution or in a finely divided form, may also be used. In embodiments, the arthropod control or arthropod repellent compositions disclosed herein are in the form of a vapor.

The concentration of the active agent(s) in any of the repellent compositions may vary in the range from about 0.00001% to about 10% by weight, depending on the formulation. A very broad latitude in the type of repellent composition and the concentration of the active agent(s) within the aforesaid range is possible.

In certain embodiments, the compositions described herein comprise two or more compounds or active agents wherein the combination of the two or more compounds or active agents is synergistic. In certain embodiments, the two or more compounds or active agents each independently have a concentration of about 0.1, 1.0, 2, 3, 4, 5, 10, 15, 20, 30, 40, 50, 60, 70, 80, 90, 100, 110, 120, 130, 140, 150, 160, 170, 180, 190, 200, 210, 220, 230, 240, 250, 260, 270, 280, 290, 300, 350, 400, 450, 500, 550, 600, 650, 700, 750, 800, 850, 800, or 1000 μg/cm².

In certain embodiments, the subject matter disclosed herein is directed to an arthropod control composition comprising pyrethrum and a second agent selected from the group consisting of:
i. a compound of Formula I

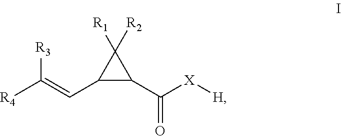

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
wherein the composition is synergistic, in admixture with a carrier.

In certain embodiments of the arthropod control composition, the composition comprises about 0.01-99.99% of pyrethrum and about 99.99-0.01% of the second agent. In certain embodiments of the arthropod control composition, the composition comprises about 0.01-99.99%, 1-99%, 5-95%, 10-90%, 20-80%, 30-70%, 40-60%, or 50% of pyrethrum and about 99.99-0.01%, 99-1%, 95-5%, 90-10%, 80-20%, 70-30%, 60-40%, or 50% of the second agent.

In certain embodiments of the arthropod control composition, the composition comprises pyrethrum and the second agent in any molar or weight ratio.

In certain embodiments of the arthropod control composition, the second agent is a compound of Formula I. In certain embodiments of the arthropod control composition, X is O. In certain embodiments, R₁ and R₂ are each methyl. In certain embodiments of the arthropod control composition, R₃ and R₄ are each independently selected from the group consisting of C₁₋C₃ alkyl and halo. In certain embodiments of the arthropod control composition, R₃ and R₄ are each independently methyl. In certain embodiments of the arthropod control composition, the compound of Formula I is

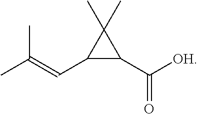

In certain embodiments of the arthropod control composition, R₃ and R₄ are each independently chloro. In certain embodiments, the compound of Formula I is

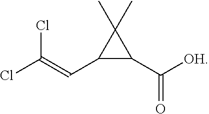

In certain embodiments of the arthropod control composition, the second agent is an essential oil. In certain embodiments of the arthropod control composition, the essential oil is selected from the group consisting of citronella oil, Amyris oil, dill seed oil, galbanum oil, cade oil, ginger root oil, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam, nutmeg oil, fennel oil, dill weed oil, balsam copaiba, and tea tree oil. In certain embodiments of the arthropod control composition, the essential oil is selected from the group consisting of citronella oil, geranium oil, and Amyris oil. In certain embodiments of the arthropod control composition, the essential oil is citronella oil.

In certain embodiments of the of the arthropod control composition, the pyrethrum and second agent each has a concentration of about 0.1, 1.0, 2, 3, 4, 5, 10, 15, 20, 30, 40, 50, 60, 70, 80, 90, 100, 110, 120, 130, 140, 150, 160, 170, 180, 190, 200, 210, 220, 230, 240, 250, 260, 270, 280, 290, 300, 350, 400, 450, 500, 550, 600, 650, 700, 750, 800, 850, 800, or 1000 μg/cm². In certain embodiments of the arthropod control composition, the pyrethrum has a concentration of about 0.001 to about 10,000 μg/cm² and the second agent has a concentration of about 1 μg/cm² to about 50,000 μg/cm². In certain embodiments of the arthropod control composition, the pyrethrum has a concentration of about 1 μg/cm², 2 μg/cm², 3 μg/cm², 4 μg/cm², 5 μg/cm², 6 μg/cm², 7 μg/cm², 8 μg/cm², 9 μg/cm², 10 μg/cm², 20 μg/cm², 25 μg/cm², 26 μg/cm², 27 μg/cm², 28 μg/cm², 29 μg/cm², 30 μg/cm², 31 μg/cm², 32 μg/cm², 33 μg/cm², 34 μg/cm², 35 μg/cm², 90 μg/cm², 91 μg/cm², 92 μg/cm², 93 μg/cm², 94 μg/cm², 95 μg/cm², 96 μg/cm², 97 μg/cm², 98 μg/cm², 99 μg/cm², 100 μg/cm², 101 μg/cm², 102 μg/cm², 103 μg/cm², 104 μg/cm², or 105 μg/cm², and the second agent has a concentration of about 1 μg/cm², 10 μg/cm², 20 μg/cm², 30 μg/cm², 40 μg/cm², 50 μg/cm², 60 μg/cm², 70 μg/cm², 80 μg/cm², 90 μg/cm², 100 μg/cm², 110 μg/cm², 120 μg/cm², 130 μg/cm², 140 μg/cm², or 150 μg/cm². In certain embodiments of the arthropod control composition, the pyrethrum has a concentration of about 0.40 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.50 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.60 ng/mg insect, 0.61 ng/mg insect, 0.62 ng/mg insect, 0.63 ng/mg insect, 0.64 ng/mg insect, or 0.65 ng/mg insect and the second agent, which is an essential oil, is present in the arthropod control composition at a concentration of about 0.5 μg/insect, 1 μg/insect, 2 μg/insect, 3 μg/insect, 4 μg/insect, 5 μg/insect, 6 μg/insect, 7 μg/insect, 8 μg/insect, 9 μg/insect, 10 μg/insect, 25 μg/insect, 35 μg/insect, 40 μg/insect, 45 μg/insect, 50 μg/insect, 55 μg/insect, 60 μg/insect, 65 μg/insect, 70 μg/insect, 75 μg/insect, 80 μg/insect, 85 μg/insect, 90 μg/insect, 95 μg/insect, 100 μg/insect, 105 μg/insect, 110 μg/insect, or 115 μg/insect. In certain embodiments of the arthropod control composition, the ratio of pyrethrum to the second agent present in the composition is about 1:1, 1:2, 1:3, 1:4, 1:5, 1:6, 1:7, 1:8, 1:9, or 1:10. In certain embodiments of the arthropod control composition, the second agent is a compound of Formula I, wherein the compound is

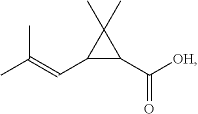

wherein said compound has a concentration of about 0.1 μg/cm² to about 1,000 μg/cm² and wherein said pyrethrum has a concentration of about 0.001 to about 100 μg/cm². In certain embodiments of the arthropod control composition,

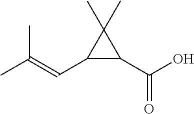

is present in the composition at a concentration of about 10 μg/cm² and the pyrethrum is present at a concentration of about 1 μg/cm², 30 μg/cm², or 100 μg/cm². In certain embodiments of the arthropod control composition,

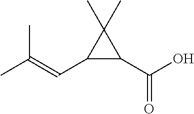

is present in the composition at a concentration of about 5, 6, 7, 8, 9, 10, 11, 12, 13, 14, or 15 μg/cm² and the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the arthropod control composition, the second agent is a compound of Formula I, wherein the compound is

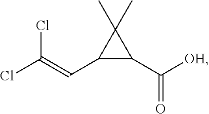

wherein said compound has a concentration of about 50 μg/cm² and wherein the pyrethrum has a concentration of about 0.001 to about 100 μg/cm². In certain embodiments of the arthropod control composition, the second agent is a compound of Formula I, wherein the compound is

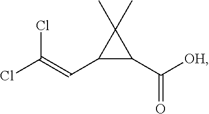

wherein said compound has a concentration of about 50 μg/cm² and wherein the pyrethrum has a concentration of about 1 μg/cm², 30 μg/cm², or 100 μg/cm². In certain embodiments of the arthropod control composition, the second agent is a compound of Formula I, wherein the compound is

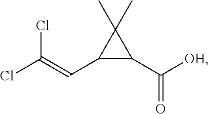

wherein said compound has a concentration of about 40, 41, 42, 43, 44, 45, 46, 47, 48, 49, 50, 51, 52, 53, 54, 55, 56, 57, 58, 59, or 60 μg/cm² and wherein the pyrethrum has a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the arthropod control composition, wherein the second agent is an essential oil, the essential oil is present at a concentration of about 90, 91, 92, 93, 94, 95, 96, 97, 98, 99, 100, 101, 102, 103, 104, 105, 106, 107, 108, 109, or 110, and wherein the pyrethrum has a concentration of about 1 μg/cm², 30 μg/cm², or 100 μg/cm². In certain embodiments of the arthropod control composition, the second agent is an essential oil, wherein the essential oil is citronella oil, wherein the citronella oil has a concentration of about 100 μg/cm² and wherein the pyrethrum has a concentration of about 0.001 to about 100 μg/cm². In certain embodiments of the arthropod control composition, the second agent is an essential oil, wherein the essential oil is citronella oil, wherein the citronella oil is present in the composition at a concentration of about 90, 91, 92, 93, 94, 95, 96, 97, 98, 99, 100, 101, 102, 103, 104, 105, 106, 107, 108, 109, or 110 μg/cm² and wherein the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the arthropod control composition, the second agent is an essential oil, wherein the essential oil is geranium oil, wherein the geranium oil has a concentration of about 100 μg/cm² and wherein the pyrethrum has a concentration of about 0.001 to about 100 μg/cm². In certain embodiments of the arthropod control composition, the second agent is an essential oil, wherein the essential oil is geranium oil, wherein the geranium oil is present in the composition at a concentration of about 90, 91, 92, 93, 94, 95, 96, 97, 98, 99, 100, 101, 102, 103, 104, 105, 106, 107, 108, 109, or 110 μg/cm² and wherein the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the arthropod control composition, the second agent is an essential oil, wherein the essential oil is Amyris oil, wherein the Amyris oil has a concentration of about 100 μg/cm² and wherein the pyrethrum has a concentration of about 0.001 to about 100 μg/cm². In certain embodiments of the arthropod control composition, the second agent is an essential oil, wherein the essential oil is Amyris oil, wherein the Amyris oil is present in the composition at a concentration of about 90, 91, 92, 93, 94, 95, 96, 97, 98, 99, 100, 101, 102, 103, 104, 105, 106, 107, 108, 109, or 110 μg/cm² and wherein the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm².

In certain embodiments of the arthropod control composition, the second component is an essential oil, wherein the essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil.

In certain embodiments of the arthropod control composition, the essential oil is selected from the group consisting of Cedarwood Virginian, dill seed oil, fennel oil, fir needle oil, and parsley, wherein said essential oil has a concentration of about 2 μg/insect. In certain embodiments of the arthropod control composition, the essential oil is selected from the group consisting of Cedarwood Virginian, dill seed oil, fennel oil, fir needle oil, and parsley, wherein said essential oil has a concentration of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3.0 μg/insect. In certain embodiments, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the arthropod control composition, the essential oil is selected from the group consisting of Amyris oil, Balsam Copaiba, Cedarwood Texas, Cedarwood Virginian, dill seed oil, fennel oil, fir needle oil, and Nutmeg EI, wherein said essential oil has a concentration of about 2 μg/insect. In certain embodiments of the arthropod control composition, the essential oil is selected from the group consisting of Amyris oil, Balsam Copaiba, Cedarwood Texas, Cedarwood Virginian, dill seed oil, fennel oil, fir needle oil, and Nutmeg EI, wherein said essential oil has a concentration of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3.0 μg/insect. In certain embodiments, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the arthropod control composition, the essential oil is selected from the group consisting of cade oil, cardamom, Cedarwood Virginian, cypress, dill weed oil, fir needle oil, guaiacwood, wherein said essential oil has a concentration of about 100 μg/insect. In certain embodiments of the arthropod control composition, the essential oil is selected from the group consisting of cade oil, cardamom, Cedarwood Virginian, cypress, dill weed oil, fir needle oil, guaiacwood, wherein said essential oil has a concentration of about 99, 99.1 99.2, 99.3, 99.4, 99.5, 99.6, 99.7, 99.8, 99.9. 100, 100.1, 100.2, 100.3, 100.4, 100.5, 100.6, 100.7, 100.8, 100.9, or 101 μg/insect. In certain embodiments, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the arthropod control composition, the essential oil is selected from the group consisting of Amyris oil, Balsam Copaiba, Cardamom, cedarleaf, Cedarwood Texas, Cedarwood Virginian, Cypress, dill seed oil, dill weed, fennel oil, ginger root, nutmeg EI, and parsley, wherein said essential oil has a concentration of about 100 μg/insect. In certain embodiments of the arthropod control composition, the essential oil is selected from the group consisting of Amyris oil, Balsam Copaiba, Cardamom, cedarleaf, Cedarwood Texas, Cedarwood Virginian, Cypress, dill seed oil, dill weed, fennel oil, ginger root, nutmeg EI, and parsley, wherein said essential oil has a concentration of about 99, 99.1 99.2, 99.3, 99.4, 99.5, 99.6, 99.7, 99.8, 99.9. 100, 100.1, 100.2, 100.3, 100.4, 100.5, 100.6, 100.7, 100.8, 100.9, or 101 μg/insect. In certain embodiments, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the arthropod control composition, the composition is capable of causing knockdown of the arthropod within one hour of exposure to the composition. In certain embodiments, the composition is capable of causing knockdown of the arthropod within fifty minutes, fifty-one minutes, fifty-two minutes, fifty-three minutes, fifty-four minutes, fifty-five minutes, fifty-six minutes, fifty-seven minutes, fifty-eight minutes fifty-nine, sixty, sixty-one, sixty-two, sixty-three, sixty-four, sixty-five, sixty-six, sixty-seven, sixty-eight, sixty-nine, seventy minutes, two hours, three hours, four hours, five hours, six hours, seven hours, eight hours, nine hours, ten hours, eleven hours, or twelve hours of exposure to the composition.

In certain embodiments of the arthropod control composition, the composition is capable of causing mortality of the arthropod within twenty-four hours of exposure to the composition. In certain embodiments, the composition is capable of causing mortality of the arthropod within twenty-three, twenty-four, or twenty-five hours of exposure to the composition.

### IV. Methods of Repelling and Controlling Arthropods

In certain embodiments, the subject matter described herein is directed to a method of providing any composition disclosed herein in an arthropod repellent medium from which a vaporized compound or composition disclosed herein can be dispersed. Non-limiting examples of suitable media include alcohols such as ethanol, glycerin and polyethylene glycol; ketones such as acetone; ethers such as tetrahydrofuran and dioxane; aliphatic hydrocarbons or petroleum distillates such as gasoline, naphtha, mineral spirits, tar, hexane, kerosene, toluene, xylene, limonene, turpentine, paraffin and petroleum benzene; esters such as ethyl acetate; and essential oils such as pine oil or citronella oil.

In certain embodiments, vaporization of the repellent may be assisted by thermal volatilization. Thermal volatilization may proceed by flame, ionizing radiation, oven, sunlight, electrical pulse, laser, gas heating element, or electric-powered heating element, such as induction heating, chemical reaction, microwave irradiation, ultrasound or a mixture thereof.

In certain embodiments, the compositions disclosed herein can be formulated for use in a vaporizer, evaporator, fan, heat, candle, or wicked apparatus.

In embodiments, the compositions disclosed herein can be used as spatial repellents. In embodiments, the compositions are in the form of a vapor. The spatial arthropod repellent compositions disclosed herein may be formulated into any suitable composition to dispense a suitable amount of the repellent compound into an environmental area in which it is desired to repel or control arthropods, wherein the arthropods do not come into contact with the locus. This repellency/control effective amount would typically range from about 1 mg/cm² down to about 1 pg/cm² or from about 100 g/cm² down to about 30 ng/cm² of the base area of the environmental area in which repellency is to be sought. In certain embodiments, the spatial arthropod repellent compositions disclosed herein may be formulated into any suitable composition to dispense a suitable amount of the repellent composition onto an object or locus, wherein the arthropods are repelled at least 1 cm, 2 cm, 1 in, 2 in, 3 in, 4 in, 5 in, 6 in, 7 in, 8 in, 9 in, 10 in, 11 in, 1 foot, 2 feet, 3 feet, 4 feet, 5 feet, 6 feet, 7 feet, 8 feet, 9 feet, 10 feet, 11 feet, 12 feet, 13 feet, 14 feet, 15 feet, 16 feet, 17 feet, 18 feet, 19 feet, 20 feet, 21 feet, 22 feet, 23 feet, 24 feet, or 25 feet from the object or locus. In certain embodiments, the spatial arthropod repellent compositions disclosed herein may be formulated into any suitable composition to dispense a suitable amount of the repellent composition onto an object or locus, wherein the arthropods are repelled about 1 cm to about 25 feet, about 2 cm to about 10 in, about 10 in to about 10 feet, about 10 feet to about 25 feet, about 1 cm to about 3 in, about 8 in to about 18 feet, or about 1 in to about 2 feet from the object or locus.

A repellent amount of the synergistic compositions described herein can vary somewhat, depending on the arthropod to be repelled, the nature of the locus, including the type of surface, from which the arthropods are to be repelled, and so forth, but generally between about 1 mg/m² and 200 mg/m² is a repellent amount. As is well known in the art, the degree of effectiveness of the repellent may vary with the formulation and the method of application.

In carrying out the methods, the synergistic compositions disclosed herein may be applied in any suitable fashion to the area in which the repellency of insect pests, including acarids, is desired. Means of effective applications are well known in the art.

In certain embodiments, the subject matter described herein is directed to a method of repelling an arthropod from an object or locus, comprising contacting said object or locus with a composition comprising pyrethrum and a second agent selected from the group consisting of:
i. a compound of Formula I

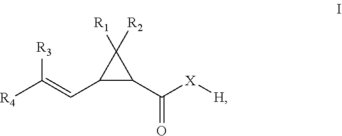

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
   wherein,
the composition is synergistic, in admixture with a carrier; and,
wherein said arthropod is repelled from an adjacent area to said object or locus,
   wherein said arthropod is not physically contacted with said object or locus.

In certain embodiments of the method of repelling an arthropod from an object or locus, the arthropod is a fly, spider, butterfly, crab, mosquito, centipede, tick, millipede, or scorpion. In certain embodiments, arthropod is a mosquito. In certain embodiments, the object or locus is an area, an environment, or the skin of an animal.

In certain embodiments of the method of repelling an arthropod from an object or locus, the second agent is a compound of Formula I. In certain embodiments of the method of repelling an arthropod from an object or locus, X is O. In certain embodiments of the method of repelling an arthropod from an object or locus, R₁ and R₂ are each methyl. In certain embodiments of the method of repelling an arthropod from an object or locus, R₃ and R₄ are each independently selected from the group consisting of C₁₋C₃ alkyl and halo. In certain embodiments of the method of repelling an arthropod from an object or locus, R₃ and R₄ are each independently methyl. In certain embodiments of the method of repelling an arthropod from an object or locus, the second agent is a compound of Formula I, which is

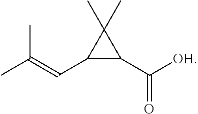

In certain embodiments of the method of repelling an arthropod from an object or locus, R₃ and R₄ are each independently chloro. In certain embodiments of the method of repelling an arthropod from an object or locus, the second agent is a compound of Formula I, which is

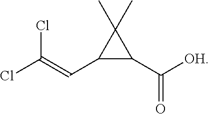

In certain embodiments of the method of repelling an arthropod from an object or locus, the second agent is an essential oil. In certain embodiments of the method of repelling an arthropod from an object or locus, the essential oil is selected from the group consisting of citronella oil, Amyris oil, dill seed oil, galbanum oil, cade oil, ginger root oil, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam, nutmeg oil, fennel oil, dill weed oil, balsam copaiba, and tea tree oil. In certain embodiments of the method of repelling an arthropod from an object or locus, the essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil. In certain embodiments of the method of repelling an arthropod from an object or locus, the essential oil is selected from the group consisting of citronella oil, geranium oil, and Amyris oil. In certain embodiments of the method of repelling an arthropod from an object or locus, the essential oil is citronella oil.

In certain embodiments of the method of repelling an arthropod from an object or locus, the pyrethrum and second agent each has a concentration of about 0.1, 1.0, 2, 3, 4, 5, 10, 15, 20, 30, 40, 50, 60, 70, 80, 90, 100, 110, 120, 130, 140, 150, 160, 170, 180, 190, 200, 210, 220, 230, 240, 250, 260, 270, 280, 290, 300, 350, 400, 450, 500, 550, 600, 650, 700, 750, 800, 850, 800, or 1000 μg/cm². In certain embodiments of the method of repelling an arthropod from an object or locus, the pyrethrum has a concentration of about 0.001 to about 10,000 μg/cm² and the second agent has a concentration of about 1 μg/cm² to about 50,000 μg/cm². In certain embodiments, the pyrethrum has a concentration of about 1 μg/cm², 2 μg/cm², 3 μg/cm², 4 μg/cm², 5 μg/cm², 6 μg/cm², 7 μg/cm², 8 μg/cm², 9 μg/cm², 10 μg/cm², 20 μg/cm², 25 μg/cm², 26 μg/cm², 27 μg/cm², 28 μg/cm², 29 μg/cm², 30 μg/cm², 31 μg/cm², 32 μg/cm², 33 μg/cm², 34 μg/cm², 35 μg/cm², 90 μg/cm², 91 μg/cm², 92 μg/cm², 93 μg/cm², 94 μg/cm², 95 μg/cm², 96 μg/cm², 97 μg/cm², 98 μg/cm², 99 μg/cm², 100 μg/cm², 101 μg/cm², 102 μg/cm², 103 μg/cm², 104 μg/cm², or 105 μg/cm², and the second agent has a concentration of about 1 μg/cm², 10 μg/cm², 20 μg/cm², 30 μg/cm², 40 μg/cm², 50 μg/cm², 60 μg/cm², 70 μg/cm², 80 μg/cm², 90 μg/cm², 100 μg/cm², 110 μg/cm², 120 μg/cm², 130 μg/cm², 140 μg/cm², or 150 μg/cm². In certain embodiments, the ratio of pyrethrum to the second agent present in the composition is about 1:1, 1:2, 1:3, 1:4, 1:5, 1:6, 1:7, 1:8, 1:9, or 1:10. In certain embodiments of the method of repelling an arthropod from an object or locus, the second agent is a compound of Formula I, wherein the compound is

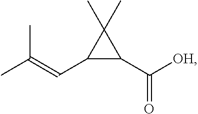

wherein said compound has a concentration of about 0.1 μg/cm² to about 1,000 μg/cm² and wherein said pyrethrum has a concentration of about 0.001 to about 100 μg/cm². In certain embodiments,

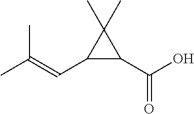

is present in the composition at a concentration of about 10 μg/cm² and the pyrethrum is present at a concentration of about 1 μg/cm², 30 μg/cm², or 100 μg/cm². In certain embodiments,

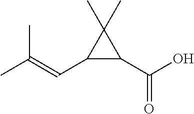

is present in the composition at a concentration of about 5, 6, 7, 8, 9, 10, 11, 12, 13, 14, or 15 μg/cm² and the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the method of repelling an arthropod from an object or locus, the second agent is a compound of Formula I, wherein the compound is

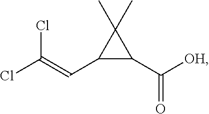

wherein said compound is present at a concentration of about 50 μg/cm² and wherein the pyrethrum is present at a concentration of about 0.001 to about 100 μg/cm². In certain embodiments of the method of repelling an arthropod from an object or locus, the second agent is a compound of Formula I, wherein the compound is

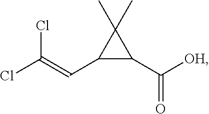

wherein said compound is present at a concentration of about 50 μg/cm² and wherein the pyrethrum is present at a concentration of about 1 μg/cm², 30 μg/cm², or 100 μg/cm². In certain embodiments of the method of repelling an arthropod from an object or locus, the second agent is a compound of Formula I, wherein the compound is

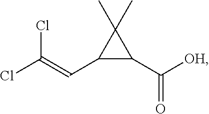

wherein said compound has a concentration of about 40, 41, 42, 43, 44, 45, 46, 47, 48, 49, 50, 51, 52, 53, 54, 55, 56, 57, 58, 59, or 60 μg/cm² and wherein the pyrethrum has a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the method of repelling an arthropod from an object or locus, the second agent is an essential oil, wherein the essential oil is present at a concentration of about 90, 91, 92, 93, 94, 95, 96, 97, 98, 99, 100, 101, 102, 103, 104, 105, 106, 107, 108, 109, or 110, and wherein the pyrethrum has a concentration of about 1 μg/cm², 30 μg/cm², or 100 μg/cm². In certain embodiments of the method of repelling an arthropod from an object or locus, the second agent is an essential oil, wherein the essential oil is citronella oil, wherein the citronella oil is present at a concentration of about 100 μg/cm² and wherein the pyrethrum is present at a concentration of about 0.001 to about 100 μg/cm². In certain embodiments of the method of repelling an arthropod from an object or locus, the second agent is an essential oil, wherein the essential oil is citronella oil, wherein the citronella oil is present in the composition at a concentration of about 90, 91, 92, 93, 94, 95, 96, 97, 98, 99, 100, 101, 102, 103, 104, 105, 106, 107, 108, 109, or 110 μg/cm² and wherein the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the method of repelling an arthropod from an object or locus, the second agent is an essential oil, wherein the essential oil is geranium oil, wherein the geranium oil has a concentration of about 100 μg/cm² and wherein the pyrethrum has a concentration of about 0.001 to about 100 μg/cm². In certain embodiments of the method of repelling an arthropod from an object or locus, the second agent is an essential oil, wherein the essential oil is geranium oil, wherein the geranium oil is present in the composition at a concentration of about 90, 91, 92, 93, 94, 95, 96, 97, 98, 99, 100, 101, 102, 103, 104, 105, 106, 107, 108, 109, or 110 μg/cm² and wherein the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the method of repelling an arthropod from an object or locus, the second agent is an essential oil, wherein the essential oil is Amyris oil, wherein the Amyris oil has a concentration of about 100 μg/cm² and wherein the pyrethrum has a concentration of about 0.001 to about 100 μg/cm². In certain embodiments of the method of repelling an arthropod from an object or locus, the second agent is an essential oil, wherein the essential oil is Amyris oil, wherein the Amyris oil is present in the composition at a concentration of about 90, 91, 92, 93, 94, 95, 96, 97, 98, 99, 100, 101, 102, 103, 104, 105, 106, 107, 108, 109, or 110 μg/cm² and wherein the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm².

In certain embodiments of the method of repelling an arthropod from an object or locus, the composition comprises the second agent in an amount of about 0.0001 to 999,999, 0.0001 to 100,000, 0.001 to 1, 0.05 to 100, 10 to 300, 60 to 700, 50 to 75, 25 to 100, 2 to 10, 100 to 500, or 300 to 1000, 800 to 10,000 parts per million.

In certain embodiments, the subject matter described herein is directed to a method for controlling one or more arthropods, comprising contacting an object or locus adjacent to said one or more arthropods with a composition comprising pyrethrum and a second agent selected from the group consisting of:
i. a compound of Formula I

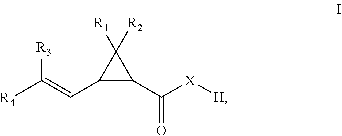

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
   wherein,
the composition is synergistic, in admixture with a carrier; and,
wherein said one or more arthropods are not physically contacted with said object or locus.

In certain embodiments of the method of controlling one or more arthropods, the arthropod is a fly, spider, butterfly, crab, mosquito, centipede, tick, millipede, or scorpion. In certain embodiments, arthropod is a mosquito. In certain embodiments, the object or locus is an area, an environment, or the skin of an animal.

In certain embodiments of the method of controlling one or more arthropods, said object or locus adjacent to said one or more arthropods is at least 1 cm, 2 cm, 1 in, 2 in, 3 in, 4 in, 5 in, 6 in, 7 in, 8 in, 9 in, 10 in, 11 in, 1 foot, 2 feet, 3 feet, 4 feet, 5 feet, 6 feet, 7 feet, 8 feet, 9 feet, 10 feet, 11 feet, 12 feet, 13 feet, 14 feet, 15 feet, 16 feet, 17 feet, 18 feet, 19 feet, 20 feet, 21 feet, 22 feet, 23 feet, 24 feet, or 25 feet from said one or more arthropods. In certain embodiments of the method of controlling one or more arthropods, said object or locus adjacent to said one or more arthropods is about 1 cm, 2 cm, 1 in, 2 in, 3 in, 4 in, 5 in, 6 in, 7 in, 8 in, 9 in, 10 in, 11 in, 1 foot, 2 feet, 3 feet, 4 feet, 5 feet, 6 feet, 7 feet, 8 feet, 9 feet, 10 feet, 11 feet, 12 feet, 13 feet, 14 feet, 15 feet, 16 feet, 17 feet, 18 feet, 19 feet, 20 feet, 21 feet, 22 feet, 23 feet, 24 feet, or 25 feet from said one or more arthropods.

In certain embodiments of the method of controlling one or more arthropods, the second agent is a compound of Formula I. In certain embodiments of the method of controlling one or more arthropods, X is O. In certain embodiments of the method of controlling one or more arthropods, R₁ and R₂ are each methyl. In certain embodiments of the method of controlling one or more arthropods, R₃ and R₄ are each independently selected from the group consisting of C₁₋C₃ alkyl and halo. In certain embodiments of the method of controlling one or more arthropods, R₃ and R₄ are each independently methyl. In certain embodiments of the method of controlling one or more arthropods, the second agent is a compound of Formula I, which is

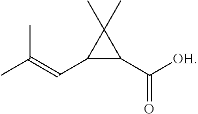

In certain embodiments of the method of controlling one or more arthropods, R₃ and R₄ are each independently chloro. In certain embodiments of the method of controlling one or more arthropods, the second agent is a compound of Formula I, which is

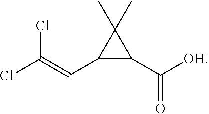

In certain embodiments of the method of controlling one or more arthropods, the second agent is an essential oil. In certain embodiments of the method of controlling one or more arthropods, the essential oil is selected from the group consisting of citronella oil, Amyris oil, dill seed oil, galbanum oil, cade oil, ginger root oil, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam, nutmeg oil, fennel oil, dill weed oil, balsam copaiba, and tea tree oil. In certain embodiments of the method of controlling one or more arthropods, the essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil. In certain embodiments of the method of controlling one or more arthropods, the essential oil is selected from the group consisting of citronella oil, geranium oil, and Amyris oil. In certain embodiments of the method of controlling one or more arthropods, the essential oil is citronella oil.

In certain embodiments of the method of controlling one or more arthropods, the pyrethrum and second agent each has a concentration of about 0.1, 1.0, 2, 3, 4, 5, 10, 15, 20, 30, 40, 50, 60, 70, 80, 90, 100, 110, 120, 130, 140, 150, 160, 170, 180, 190, 200, 210, 220, 230, 240, 250, 260, 270, 280, 290, 300, 350, 400, 450, 500, 550, 600, 650, 700, 750, 800, 850, 800, or 1000 μg/cm².

In certain embodiments of the method of controlling one or more arthropods, the pyrethrum and second agent each has a concentration of about 0.1, 1.0, 2, 3, 4, 5, 10, 15, 20, 30, 40, 50, 60, 70, 80, 90, 100, 110, 120, 130, 140, 150, 160, 170, 180, 190, 200, 210, 220, 230, 240, 250, 260, 270, 280, 290, 300, 350, 400, 450, 500, 550, 600, 650, 700, 750, 800, 850, 800, or 1000 μg/cm². In certain embodiments of the method of controlling one or more arthropods, the pyrethrum has a concentration of about 0.001 to about 10,000 μg/cm² and the second agent has a concentration of about 1 μg/cm² to about 50,000 μg/cm². In certain embodiments of the method of controlling one or more arthropods, the pyrethrum has a concentration of about 1 μg/cm², 2 μg/cm², 3 μg/cm², 4 μg/cm², 5 μg/cm², 6 μg/cm², 7 μg/cm², 8 μg/cm², 9 μg/cm², 10 μg/cm², 20 μg/cm², 25 μg/cm², 26 μg/cm², 27 μg/cm², 28 μg/cm², 29 μg/cm², 30 μg/cm², 31 μg/cm², 32 μg/cm², 33 μg/cm², 34 μg/cm², 35 μg/cm², 90 μg/cm², 91 μg/cm², 92 μg/cm², 93 μg/cm², 94 μg/cm², 95 μg/cm², 96 μg/cm², 97 μg/cm², 98 μg/cm², 99 μg/cm², 100 μg/cm², 101 μg/cm², 102 μg/cm², 103 μg/cm², 104 μg/cm², or 105 μg/cm², and the second agent has a concentration of about 1 μg/cm², 10 μg/cm², 20 μg/cm², 30 μg/cm², 40 μg/cm², 50 μg/cm², 60 μg/cm², 70 μg/cm², 80 μg/cm², 90 μg/cm², 100 μg/cm², 110 μg/cm², 120 μg/cm², 130 μg/cm², 140 μg/cm², or 150 μg/cm². In certain embodiments of the method of controlling one or more arthropods, the ratio of pyrethrum to the second agent present in the composition is about 1:1, 1:2, 1:3, 1:4, 1:5, 1:6, 1:7, 1:8, 1:9, or 1:10. In certain embodiments of the method of controlling one or more arthropods, the second agent is a compound of Formula I, wherein the compound is

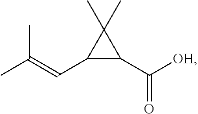

wherein said compound has a concentration of about 0.1 μg/cm² to about 1,000 μg/cm² and wherein said pyrethrum has a concentration of about 0.001 to about 100 μg/cm². In certain embodiments of the method of controlling one or more arthropods,

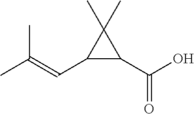

is present in the composition at a concentration of about 10 μg/cm² and the pyrethrum is present at a concentration of about 1 μg/cm², 30 μg/cm², or 100 μg/cm². In certain embodiments of the method of controlling one or more arthropods,

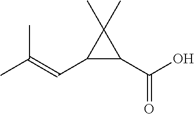

is present in the composition at a concentration of about 5, 6, 7, 8, 9, 10, 11, 12, 13, 14, or 15 μg/cm² and the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, or 99 100 μg/cm². In certain embodiments of the method of controlling one or more arthropods, the second agent is a compound of Formula I, wherein the compound is

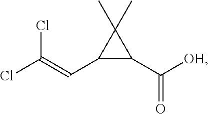

wherein said compound has a concentration of about 50 μg/cm² and wherein the pyrethrum has a concentration of about 0.001 to about 100 μg/cm². In certain embodiments of the method of controlling one or more arthropods, the second agent is a compound of Formula I, wherein the compound is

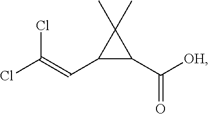

wherein said compound has a concentration of about 50 μg/cm² and wherein the pyrethrum has a concentration of about 1 μg/cm², 30 μg/cm², or 100 μg/cm². In certain embodiments of the method of controlling one or more arthropods, the second agent is a compound of Formula I, wherein the compound is

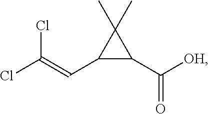

wherein said compound has a concentration of about 40, 41, 42, 43, 44, 45, 46, 47, 48, 49, 50, 51, 52, 53, 54, 55, 56, 57, 58, 59, or 60 μg/cm² and wherein the pyrethrum has a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the method of controlling one or more arthropods, the second agent is an essential oil, wherein the essential oil is present at a concentration of 90, 91, 92, 93, 94, 95, 96, 97, 98, 99, 100, 101, 102, 103, 104, 105, 106, 107, 108, 109, or 110, and wherein the pyrethrum has a concentration of about 1 μg/cm², 30 μg/cm², or 100 μg/cm². In certain embodiments of the method of controlling one or more arthropods, the second agent is an essential oil, wherein the essential oil is citronella oil, wherein the citronella oil has a concentration of about 100 μg/cm² and wherein the pyrethrum has a concentration of about 0.001 to about 100 μg/cm². In certain embodiments of the method of controlling one or more arthropods, the second agent is an essential oil, wherein the essential oil is citronella oil, wherein the citronella oil is present in the composition at a concentration of about 90, 91, 92, 93, 94, 95, 96, 97, 98, 99, 100, 101, 102, 103, 104, 105, 106, 107, 108, 109, or 110 μg/cm² and wherein the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the method of controlling one or more arthropods, the second agent is an essential oil, wherein the essential oil is geranium oil, wherein the geranium oil has a concentration of about 100 μg/cm² and wherein the pyrethrum has a concentration of about 0.001 to about 100 μg/cm². In certain embodiments of the method of controlling one or more arthropods, the second agent is an essential oil, wherein the essential oil is geranium oil, wherein the geranium oil is present in the composition at a concentration of about 90, 91, 92, 93, 94, 95, 96, 97, 98, 99, 100, 101, 102, 103, 104, 105, 106, 107, 108, 109, or 110 μg/cm² and wherein the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm². In certain embodiments of the method of controlling one or more arthropods, the second agent is an essential oil, wherein the essential oil is Amyris oil, wherein the Amyris oil has a concentration of about 100 μg/cm² and wherein the pyrethrum has a concentration of about 0.001 to about 100 μg/cm². In certain embodiments of the method of controlling one or more arthropods, the second agent is an essential oil, wherein the essential oil is Amyris oil, wherein the Amyris oil is present in the composition at a concentration of about 90, 91, 92, 93, 94, 95, 96, 97, 98, 99, 100, 101, 102, 103, 104, 105, 106, 107, 108, 109, or 110 μg/cm² and wherein the pyrethrum is present at a concentration of about 1, 2, 3, 4, 5, 20, 21, 22, 23, 24, 25, 26, 27, 28, 29, 30, 31, 32, 33, 34, 45, 36, 37, 38, 39, 40, 41, 42, 43, 44, 45, 46, 47, 48, 49, 50, 51, 52, 53, 54, 55, 80, 81, 82, 83, 84, 85, 86, 87, 88, 89, 90, 91, 92, 93, 94, 95, 96, 97, 98, 99, or 100 μg/cm².

In certain embodiments, the subject matter disclosed herein is directed to a method of repelling a species of arthropod from a locus, comprising contacting on said locus an arthropod control composition comprising pyrethrum and a second agent selected from the group consisting of:
i. a compound of Formula I

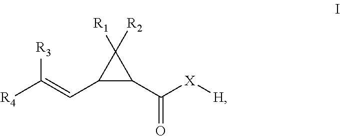

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
   wherein said composition is synergistic, in admixture with a carrier.

In certain embodiments of the above method, the composition is a solution, dust, granular formulation, or emulsion.

In certain embodiments of the above method, the composition is an essential oil.

In certain embodiments of the above embodiment, essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil.

In certain embodiments of the above method, the essential oil is selected from the group consisting of Cedarwood Virginian, dill seed oil, fennel oil, fir needle oil, and parsley, wherein the essential oil has a concentration of about 2 μg/insect. In certain embodiments of the above method, the essential oil has a concentration of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3.0 μg/insect. In certain embodiments of the above method, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the above method, the essential oil is selected from the group consisting of Amyris oil, Balsam Copaiba, Cedarwood Texas, Cedarwood Virginian, dill seed oil, fennel oil, fir needle oil, and Nutmeg EI, wherein the essential oil has a concentration of about 2 μg/insect. In certain embodiments of the above method, the essential oil has a concentration of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3.0 μg/insect. In certain embodiments of the above method, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the above method, the essential oil is selected from the group consisting of cade oil, cardamom, Cedarwood Virginian, cypress, dill weed oil, fir needle oil, guaiacwood, wherein the essential oil has a concentration of about 100 μg/insect. In certain embodiments of the above method, the essential oil has a concentration of about 99, 99.1 99.2, 99.3, 99.4, 99.5, 99.6, 99.7, 99.8, 99.9. 100, 100.1, 100.2, 100.3, 100.4, 100.5, 100.6, 100.7, 100.8, 100.9, or 101 μg/insect. In certain embodiments of the above method, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the above method, the essential oil is selected from the group consisting of Amyris oil, Balsam Copaiba, Cardamom, cedarleaf, Cedarwood Texas, Cedarwood Virginian, Cypress, dill seed oil, dill weed, fennel oil, ginger root, nutmeg EI, and parsley, wherein said essential oil has a concentration of about 100 μg/insect. In certain embodiments of the above method, the essential oil has a concentration of about 99, 99.1 99.2, 99.3, 99.4, 99.5, 99.6, 99.7, 99.8, 99.9. 100, 100.1, 100.2, 100.3, 100.4, 100.5, 100.6, 100.7, 100.8, 100.9, or 101 μg/insect. In certain embodiments of the above method, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments, the subject matter disclosed herein is directed to a method of controlling one or more arthropods, comprising contacting the one or more arthropods with an arthropod control composition comprising pyrethrum and a second agent selected from the group consisting of:
i. a compound of Formula I

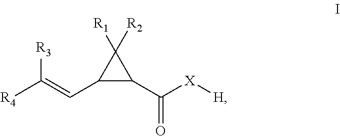

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
   wherein said composition is synergistic, in admixture with a carrier.

In certain embodiments of the above method, the composition is a solution, dust, granular formulation, or emulsion.

In certain embodiments of the above method, the composition is an essential oil.

In certain embodiments of the above embodiment, the essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil.

In certain embodiments of the above method, the essential oil is selected from the group consisting of Cedarwood Virginian, dill seed oil, fennel oil, fir needle oil, and parsley, wherein the essential oil has a concentration of about 2 μg/insect. In certain embodiments of the above method, the essential oil has a concentration of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3.0 μg/insect. In certain embodiments of the above method, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the above method, the essential oil is selected from the group consisting of Amyris oil, Balsam Copaiba, Cedarwood Texas, Cedarwood Virginian, dill seed oil, fennel oil, fir needle oil, and Nutmeg EI, wherein the essential oil has a concentration of about 2 μg/insect. In certain embodiments of the above method, the essential oil has a concentration of about 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, or 3.0 μg/insect. In certain embodiments of the above method, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the above method, the essential oil is selected from the group consisting of cade oil, cardamom, Cedarwood Virginian, cypress, dill weed oil, fir needle oil, guaiacwood, wherein the essential oil has a concentration of about 100 μg/insect. In certain embodiments of the above method, the essential oil has a concentration of about 99, 99.1 99.2, 99.3, 99.4, 99.5, 99.6, 99.7, 99.8, 99.9. 100, 100.1, 100.2, 100.3, 100.4, 100.5, 100.6, 100.7, 100.8, 100.9, or 101 μg/insect. In certain embodiments of the above method, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the above method, the essential oil is selected from the group consisting of Amyris oil, Balsam Copaiba, Cardamom, cedarleaf, Cedarwood Texas, Cedarwood Virginian, Cypress, dill seed oil, dill weed, fennel oil, ginger root, nutmeg EI, and parsley, wherein said essential oil has a concentration of about 100 μg/insect. In certain embodiments of the above method, the essential oil has a concentration of about 99, 99.1 99.2, 99.3, 99.4, 99.5, 99.6, 99.7, 99.8, 99.9. 100, 100.1, 100.2, 100.3, 100.4, 100.5, 100.6, 100.7, 100.8, 100.9, or 101 μg/insect. In certain embodiments of the above method, the pyrethrum has a concentration of about 0.1, 0.2, 0.3, 0.4 ng/mg insect, 0.41 ng/mg insect, 0.42 ng/mg insect, 0.43 ng/mg insect, 0.44 ng/mg insect, 0.45 ng/mg insect, 0.46 ng/mg insect, 0.47 ng/mg insect, 0.48 ng/mg insect, 0.49 ng/mg insect, 0.5 ng/mg insect, 0.51 ng/mg insect, 0.52 ng/mg insect, 0.53 ng/mg insect, 0.54 ng/mg insect, 0.55 ng/mg insect, 0.56 ng/mg insect, 0.57 ng/mg insect, 0.58 ng/mg insect, 0.59 ng/mg insect, 0.6 ng/mg insect, 0.61 ng/mg insect, 0.62 ng/mg insect, 0.63 ng/mg insect, 0.64 ng/mg insect, 0.65 ng/mg insect, 0.7 ng/mg insect, 0.8 ng/mg insect, 0.9 ng/mg insect, 1.0 ng/mg insect, 1.1 ng/mg insect, 1.2 ng/mg insect, 1.3 ng/mg insect, 1.4 ng/mg insect, 1.5 ng/mg insect, 1.6 ng/mg insect, 1.7 ng/mg insect, 1.8 ng/mg insect, 1.9 ng/mg insect, 2.0 ng/mg insect, 2.1 ng/mg insect, 2.2 ng/mg insect, 2.3 ng/mg insect, 2.4 ng/mg insect, or 2.5 ng/mg insect.

In certain embodiments of the above method, the one or more arthropods experiences knockdown within one hour of exposure to the composition.

In certain embodiments of the above method, the one or more arthropods reaches its mortality within twenty-four hours of exposure to said composition.

In certain embodiments of the method of controlling one or more arthropods, the composition comprises the second agent in an amount of about 0.0001 to 999,999, 0.0001 to 100,000, 0.001 to 1, 0.05 to 100, 10 to 300, 60 to 700, 50 to 75, 25 to 100, 2 to 10, 100 to 500, or 300 to 1000, 800 to 10,000 parts per million.

In certain embodiments, the arthropods repelled by the compositions or methods disclosed herein are insects. In certain embodiments, the insects repelled by the compositions or methods disclosed herein are Hemiptera Insects, selected from Delphacidae (planthoppers), such as Laodelphax striatellus (small brown planthopper), Nilaparvata lugens (brown planthopper), Sogatella furcifera (white-backed rice planthopper); Deltocephalidae (leafhoppers), such as Nephotettix cincticeps (green rice leafhopper), Recilia dorsalis (zig-zag rice leaf hopper), Nephotettix virescens (green rice leafhopper); Aphididae (aphids), stink bugs, Aleyrodidae (whiteflies), scales, Tingidae (lace bugs), or Psyllidae (suckers).

In certain embodiments, the insects repelled by the compositions or methods disclosed herein are Lepidoptera Insects, selected from Pyralidae, such as Chilo suppressalis (rice stem borer), Cnaphalocrocis medinalis (rice leafroller), Plodia interpunctella (Indian meal moth); Noctuidae, such as Spodoptera litura (tobacco cutworm), Pseudaletia separata (rice armyworm), Mamestra brassicae (cabbage armyworm); Pieridae, such as Pieris rapae crucivora (common cabbageworm); Tortricidae, such as Adoxophyes spp.; Carposinidae; Lyonetiidae; Lymantriidae; Plusiinae; Agrotis spp. such as Agrotis segetum (turnip cutworm), or Agrotis ipsilon (black cutworm); Helicoverpa spp.; Heliothis spp.; Plutella xylostella; Parnara guttata (rice skipper); Tinea pellionella (casemaking clothes moth); or Tineola bisselliella (webbing clothes moth).

In certain embodiments, the insects repelled by the compositions or methods disclosed herein are Diptera Insects, Culex spp., such as Culex pipiens pallens (common mosquito), Culex tritaeniorhynchus, Aedes spp., such as Aedes aegypti, Aedes albopictus; Anopheles spp., such as Anopheles sinensis; Chironomidae (midges); Muscidae, such as Musca domestica (housefly), Muscina stabulans (false stablefly), Fannia canicularis (little housefly); Calliphoridae; Sarcophagidae; Anthomyiidae, such as Delia platura (seedcorn maggot), Delia antiqua (onion maggot); Tephritidae (fluit flies); Drosophilidae; Psychodidae (moth flies); Tabanidae; Simuliidae (black flies); Stomoxyidae (stable flies); Phoridae; or Ceratopogonidae (biting midges).

In certain embodiments, the insects repelled by the compositions or methods disclosed herein are Coleoptera Insects (Beetles), several nonlimiting examples of which include Corn rootworms, such as Diabrotica virgifera (western corn rootworm), Diabrotica undecimpunctata howardi (southern corn rootworm); Scarabaeidae (scarabs), such as Anomala cuprea (cupreous chafer), Anomala rufocuprea (soybean beetle); Curculionidae (weevils), such as Sitophilus zeamais (maize weevil), Lissorhoptrus oryzophilus (ricewater weevil), ball weevil, Callosobruchus chinensis (adzuki bean weevil); Dermestidae, such as Authrenus verbasci (varied carpet beetle), Attagenus unicolor japonicus (black carpet beetle); Tenebrionidae (darkling beetles), such as Tenebrio molitor (yellow mealworm), or Tribolium castaneum (red flour beetle); Chrysomelidae (leaf beetles) such as Oulema oryzae (rice leaf beetle), Phyllotreta striolata (striped flea beetle), Aulacophora femoralis (cucurbit leaf beetle); Anobiidae; Epilachna spp. such as Epilachna vigintioctopunctata (twenty-eight-spotted ladybird); Lyctidae (powderpost beetles), Bostrychidae (false powderpost beetles), or Cerambycidae, Paederus fuscipes (robe beetle).

In certain embodiments, the insects repelled by the compositions or methods disclosed herein are Dictyoptera Insects, such as the following: Blattella germanica (German cockroach); Periplaneta fuliginosa (smokybrown cockroach); Periplaneta americana (American cockroach); Periplaneta brunnea (brown cockroach); or Blatta orientalis (oriental cockroach).

In certain embodiments, the insects repelled by the compositions or methods disclosed herein are Thysanoptera Insects (Thrips), such as Thrips palmi, Flankliniella occidentalis (western flower Thrips), or Thrips hawaiiensis (flower Thrips).

In certain embodiments, the insects repelled by the compositions or methods disclosed herein are Hymenoptera Insects, such as Formicidae (ants); Vespidae (hornets); Polistes spp. (long-legged wasps); Bethylidae; or Tenthredinidae (sawflies), such as Athalis rosae ruficornis (cabbage sawfly).

In certain embodiments, the insects repelled by the compositions or methods disclosed herein are Orthoptera Insects, such as Gryllotalpidae (mole crickets); or Acrididae (grasshoppers).

In certain embodiments, the insects repelled by the compositions or methods disclosed herein are Siphonaptera Insects (Fleas), such as Ctenocephalides canis (dog flea); Ctenocephalides felis (cat flea); or Pulex irritans.

In certain embodiments, the insects repelled by the compositions or methods disclosed herein are Anoplura Insects (Lice), such as Pediculus corporis (body louse); Pediculus humanus (head louse); or Pthirus pubis (crab louse).

In certain embodiments, the insects repelled by the compositions or methods disclosed herein are Isoptera Insects, such as Reticulitermes speratus; Coptotermes formosanus (Formosan subterranean termite).

In certain embodiments, the insects repelled by the compositions or methods disclosed herein are Harmful Acarina, such as Ixodidae (Ticks): Boophulus microplus; Haemaphysalis longiconis Tetranychidae (spider mites): Tetranychus cinnabarinus (carmine spider mite); Tetranychus urticae (two-spotted spider mite); Tetranychus kanzawai (Kanzawa spider mite); Panonychus citri (citrus red mite); Panonychus ulmi (European red mite); House-dust Mites: Acaridae such as Tyrophagus putrescentiae (copra mite), Aleuroglyphus ovatus (brown legged grain mite); Dermanyssidae such as Dermatophagoides farinae (American house dust mite), Dermatophagoides pteronyssinus; mites parasitizing honeybees, such as Varroa jacobsoni; Euvarroa sinhai, Acarapis woodi; Tropilaelaps clareae; Glycyphagidae, such as Glycyphagus privatus, Glycyphagus domesticus, Glycyphagus destructor; Cheyletidae, such as Chelacaropsis malaccensis, Cheyletus fortis; Tarsonemidae; Chortoglyphus spp.; Haplochthonius spp. Chilognatha (millipedes), such as Oxydus spp.; Chilopoda (centipedes), such as red centipede; wood lice, such as Porcellio spp., Porcellionides spp.; and pill bugs, such as Armadillidium spp.

In certain embodiments, the arthropod repelled by the compositions or methods disclosed herein is selected from the group consisting of a fly, spider, butterfly, crab, mosquito, centipede, tick, millipede, and scorpion. In certain embodiments, the arthropod repelled by the compounds, compositions, or methods disclosed herein is selected from the group consisting of a fly, spider, butterfly, crab, mosquito, centipede, tick, millipede, scorpion, roache, ant, termite, silverfish, and wasp. In certain embodiments, the arthropod is an insect.

In certain embodiments, the insect is a mosquito. In certain embodiments, the mosquito genera is selected from the group consisting of Culex, Anopheles, and Aedes. In certain embodiments, the mosquito is of the species, Aedes aegypti.

### V. Essential Oils

As used herein, non-limiting examples of essential oils include Almond Oil Bitter, Almond Oil Sweet, Amyris Oil W.I., Angelica Root Oil, Angelica Seed Oil, Anise Oil Chinese, Anise Oil Spanish, Anise Oil Vietnam, Aniseed Oil, Aniseed Oil Terpenes, Apricot Kernel Oil, Armoise Oil, Artemesia Afra, Asafoetida Oil, Avocado Oil, Balsam Copaiba, Balsam Copaiba Oil, Balsam Fir Canada, Balsam Peru, Balsam Peru Oil, Balsam Tolu PG, Basil Oil Comores Type, Basil Oil Indian, Basil Oil Linalool Type, Bay Oil Terpeneless Type, Bay Oil W.I., Bay Oil W.I. Bleached & Filtered, Bay Terpenes PG, Beeswax Absolute, Benzoin Siam Resin, Bergamot Oil, Bergamot Oil B.F., Bergamot Oil Residues, Bergamot Oil Terpenes, Birch Tar Crude, Birch Tar Rectified, Black Currant Bud Absolute, Blood Orange Oil, Bois de Rose Oil, Boronia Absolute Tasmanian, Brominated Vegetable Oil, Buchu Leaf Oil Betulina, Buchu Leaf Oil Crenulata, Buchu Oil, Sulfur Fractions 40%, Cabreuva Oil, Cade Oil, Cade Oil Rectified, Cajeput Oil, Calamus Oil, Camphor Oil 1.070, Camphor Oil Chinese, Camphor Oil White Taiwan, Cananga Oil, Caraway Oil, Cardamom Oil, Carrot Seed Oil, Carvene, Cascarilla Bark Oil, Cassia Oil, Catnip Oil, Cedarleaf Oil, Cedarwood Oil (i.e. Cedarwood Oil Atlas, Cedarwood Oil Chinese, Cedarwood Oil Texas, Cedarwood Oil Texas Redistilled, and Cedarwood Oil Virginiana), Celery Seed Oil, Chamomile Oil Blue, Chamomile Oil Roman, Chamomile Oil Wild Maroc, Cinnamon Bark Oil, Cinnamon Leaf Oil Ceylon, Cistus Absolute, Cistus Oil, Citronella Oil Java 85/35, Citronella Oil Chinese 85/35, Citronella Oil Ceylon, Citronella Terpenes, Clove Bud Indonesian, Clove Bud Oil Prime, Clove Leaf Oil Indonesian 70/80, Clove Leaf Oil Madagascar 80/82, Clove Leaf Oil Redistilled, Clove Stem Oil, Clove Terpenes, Coffee Oil, Cognac Oil Green, Cognac oil, Coriander Herb Oil (Cilantro), Coriander Seed Oil, Cornmint Oil 50% Dementh. India, Cornmint Oil 50% Dementh. China, Cornmint Oil Rectified, Cubeb Oil, Cumin Seed Oil, Cypress Oil, Davana Oil, Dillseed Oil, Dillweed Oil, Eucalyptus citriodora Brazil, Eucalyptus citriodora Chinese, Eucalyptus Oil 70/75, Eucalyptus Oil 80/85, Eucalyptus Oil Terpenes, Eucalyptus smithii Oil S.A., Evening Primrose, Fennel Oil, Fennel Oil Bitter, Fennel Oil Sweet, Fir Balsam Absolute, Fir Balsam Concrete, Fir Balsam Canadian, Fir Needle Oil Canadian, Fir Needle Oil Siberian, Fir Needle Oil Chinese, Galangal Root Oil, Galbanum Oil, Galbanum Resinoid, Garlic Oil Chinese, Garlic Oil Mexican, Genet Absolute, Geranium Oil Chinese, Geranium Oil Egyptian, Ginger Oil Chinese, Ginger Oil Fresh, Ginger Oil Indian, Grapefruit Oil 5×, Grapefruit Oil Pink C.P., Grapefruit Oil Washed, Grapefruit Oil White C.P., Grapefruit Terpenes, Grapeseed Oil, Gum Benzoin Siam Resin, Gurjon Balsam Oil, Guaiacwood Oil, Helichrysum Oil, Hemlock Oil, Ho Leaf Oil, Hop Oil, Horseradish Oil, Howood Oil 95%, Hyssop Oil, Jasmine Absolute, Jojoba Oil Purified White, Juniperberry Oil, Labdanum Gum Refined, Lanyana Oil, Laurel Leaf Oil, Lavandin Abrialis, Lavandin Grosso, Lavender Absolute Bulgarian, Lavender Oil 16%, Lavender Oil 40/42 French, Lavender Oil Bulgarian, Lavender Oil Spike, Lemon Essence Oil, Lemon Oil Argentina, Lemon Oil Brazil, Lemon Oil California 5×, Lemon Oil California Type, Lemon Oil Distilled, Lemon Oil Israeli, Lemon Oil Washed, Lemon Terpenes, Lemongrass Oil Guatemalan, Lemongrass Oil East Indian, Lemongrass Terpenes, Lemongrass Oil Terpeneless, Lime Essence Oil Phase, Lime Oil Mexican C.P., Types A & B, Lime Oil Distilled Mexican, Lime Oil Distilled Terpenes, Lime Oil Expressed Terpenes, Lime Oil Peru Distilled, Lime Oil Washed, Lime Sesqui Fractions, Lime Terpenes, Litsea cubeba Oil, Litsea Terpenes, Lovage Leaf Oil, Lovage Root Oil, Mandarin Essence Oil Phase, Mandarin Oil Brazil, Mandarin Oil Green, Mandarin Oil Italian, Mandarin Oil Red Argentina, Mandarin Terpenes, Mandarin Petitgrain Terpeneless, Marjoram Oil Spanish, Marjoram Oil Sweet Egyptian, Massoia Bark Oil, Melissa Oil, Mentha arvensis Oil, Mentha citrata Oil, Mentha piperita Oil, Milfoil Oil, Mimosa Absolute, Mousse de Arbre, Mousse de Pin Absolute, Mustard Oil Natural, Mustard Oil Synthetic, Myrrh Oil, Myrtle Oil, Neroli Oil, Nutmeg Oil, Nutmeg Oil Ceylon, Nutmeg Oil E.I., Nutmeg Terpenes, Oakmoss Absolute Green, Ocotea Cymbarum, Olibanum Oil, Olibanum Resin, Opoponax Oil, Onion Oil Egyptian, Onion Oil Mexican, Orange Juice Oil BJ N&A, Orange Essence Oil Phase, Orange Oil 5×, Orange Oil 10×, Orange Oil Bitter Ivory Coast Type, Orange Oil Bitter West Indian, Orange Oil Bitter Brazil, Orange Oil S.A., Orange Oil Midseason, Orange Oil Valencia, Orange Oil Terpeneless, Orange Terpenes, Organic Artemesia Oil, Organic Balsam Copaiba Oil, Organic Bois de Rose Oil, Organic Dillweed Oil, Organic Juniper Berry Oil, Organic Lavender Oil, Bulgarian, Organic Peppermint Oil, Organic Tea Tree Oil, Organic Wormwood Oil European, Organic Zdravetz Oil, Origanum Oil, Orris Root Concrete 8% Irone, Palmarosa Oil, Parsley Leaf Oil, Parsley Seed Oil, Patchouli Oil Indonesian, Patchouli Oil Light, Patchouli Oil Molecular Distilled, Pennyroyal Oil, Pepper Oil Black, Peppermint Oil Hotchkiss Type, Peppermint Oil Mitcham Type, Peppermint Oil Piperita Chinese, Peppermint Oil Piperita Indian, Peppermint Oil Piperita Redistilled, Peppermint Oil Piperita Williamette, Peppermint Oil Piperita Yakima, Peppermint Oil Terpenes, Perilla Oil, Petitgrain Oil S.A., Petitgrain Terpenes, Pimento Berry Oil, Pimento Leaf Oil, Pink Pepper Oil (Schinus molle), Pinus Oil Pumilio, pinus Oil Sylvestris, Rose Absolute Bulgarian, Rose Absolute Maroc, Rose Concrete Bulgarian, Rose Oil Bulgarian, Rose Oil Maroc, Rose Oil Turkish, Rose Water Concentrate, Rosemary Oil Maroc, Rosemary Oil Spanish, Rosemary Oil Tunisian, Rue Oil, Sage Oil 30%, Sage Oil 50%, Sage Oil Clary, Sage Oil Spanish, Sandalwood Oil Australian, Sandalwood Oil East Indian, Sandalwood Oil Indonesian, Sandalwood Oil Sri Lanka, Sassafras Oil, Savory Oil, Siamwood Oil, Spearmint Oil 65% Indian, Spearmint Oil Chinese 60%, Spearmint Oil Chinese 80%, Spearmint Oil Native, Spearmint Oil Terpeneless, Spearmint Terpenes, Spike Lavender Oil, Spikenard Oil, Spruce Absolute, Spruce Oil Canadian, Styrax Gum Honduras, Styrax Oil Honduras, Tagetes Oil Argentina, Tagetes Oil South African, Tagetes Oil Zimbabwe, Tangerine Oil 5×, Tangerine Oil 10×, Tangerine Oil CP China, Tangerine Oil CP Cravo, Tangerine Oil CP Florida, Tangerine Terpenes, Tarragon Oil, Tea Tree Oil, Thuja Oil, Thyme Oil Red, Thyme Oil White, Tolu Balsam, Tonka Bean Absolute, Perfume Grade, Treemoss Absolute, Tuberose Absolute, Valerian Root Oil, Vetiver Oil Indonesian, Vetiver Terpenes, Vetiver Oil Brazil, Violet Leaf Absolute, Wintergreen Oil Redistilled, Wormwood Oil American, Wormwood Oil European, Yarrow Oil (Milfoil), Ylang Oil #1, Ylang Oil #2, Ylang Oil #3, Ylang Oil Extra, and Zdravetz Oil.

The subject matter described herein includes the following embodiments:

1. An arthropod control composition comprising pyrethrum and a second agent selected from the group consisting of:
i. a compound of Formula I

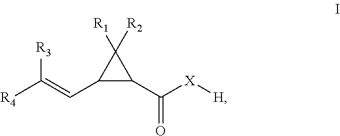

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
   wherein said composition is synergistic, in admixture with a carrier.
   2. The arthropod control composition of embodiment 1, wherein said composition is a vapor.
   2a. The arthropod control composition of embodiment 1 or 2, wherein said pyrethrum is present at a concentration of about 0.01 μg/cm² to about 10,000 μg/cm², and said second agent is present at a concentration of about 0.01 μg/cm² to about 50,000 μg/cm².
   3. The arthropod control composition of any one of embodiments 1-2, wherein said second agent is a compound of Formula I.
   4. The arthropod control composition of any one of embodiments 1-3, wherein X is O.
   5. The arthropod control composition of any one of embodiments 1-4, wherein R₁ and R₂ are each methyl.
   6. The arthropod control composition of any one of embodiments 1-5, wherein R₃ and R₄ are each independently selected from the group consisting of C₁₋C₃ alkyl and halo.
   7. The arthropod control composition of any one of embodiments 1-6, wherein R₃ and R₄ are each independently methyl.
   8. The arthropod control composition of any one of embodiments 1-7, wherein said compound of Formula I is

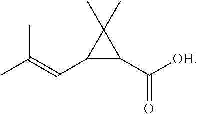

9. The arthropod control composition of embodiment 1, wherein,
said second agent is a compound of Formula I, wherein said compound is

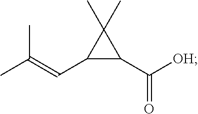

said pyrethrum is present in said arthropod control composition at a concentration of about 0.01 μg/cm² to about 10,000 μg/cm²; and
said second agent is present in said arthropod control composition at a concentration of about 0.1 μg/cm² to about 1,000 μg/cm².
   9a. The arthropod control composition of embodiment 9, wherein said pyrethrum is present in said arthropod control composition at a concentration of about 1 μg/cm², 30 μg/cm², or 100 μg/cm²; and, said second agent is present in said arthropod control composition at a concentration of about 10 μg/cm².
   10. The arthropod control composition of any one of embodiments 1-6, wherein R₃ and R₄ are each independently chloro.
   11. The arthropod control composition of embodiment 10, wherein said compound of Formula I is

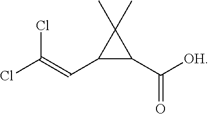

12. The arthropod control composition of embodiment 1, wherein,
said second agent is a compound of Formula I, wherein said compound is

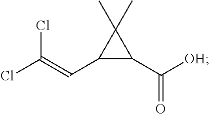

said pyrethrum is present in said arthropod control composition at a concentration of about 0.01 μg/cm² to about 10,000 μg/cm²; and,
said second agent is present in said arthropod control composition at a concentration of about 0.5 μg/cm² to about 5,000 μg/cm².
   12a. The arthropod control composition of embodiment 12, wherein said pyrethrum is present in said arthropod control composition at a concentration of about 1 μg/cm², 30 μg/cm², or 100 μg/cm²; and, said second agent is present in said arthropod control composition at a concentration of about 50 μg/cm².
   12b. The arthropod control composition of embodiment 1, wherein the composition is a solution, dust, granular formulation, or emulsion.
   13. The arthropod control composition of embodiment 1 or 2, wherein said second agent is an essential oil.
   13a. The arthropod control composition of embodiment 1, 2, 12b, or 13, wherein said essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil.
   14. The arthropod control composition of embodiment 1, 2, 13a, or 13, wherein said essential oil is selected from the group consisting of citronella oil, Amyris oil, dill seed oil, galbanum oil, cade oil, ginger root oil, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam, nutmeg oil, fennel oil, dill weed oil, balsam copaiba, and tea tree oil.
   15. The arthropod control composition of embodiment 13a or 14, wherein said essential oil is selected from the group consisting of citronella oil, geranium oil, and Amyris oil.
   16. The arthropod control composition of embodiment 15, wherein said essential oil is citronella oil.
   17. The arthropod control composition of embodiment 1, wherein,
said second agent is an essential oil, wherein said essential oil is selected from the group consisting of citronella oil, geranium oil, and Amyris oil;
said pyrethrum is present in said arthropod control composition at a concentration of about 0.01 μg/cm² to about 10,000 μg/cm²; and,
said essential oil is present in said arthropod control composition at a concentration of about 1 μg/cm² to about 10,000 μg/cm².
   17a. The arthropod control composition of embodiment 17, wherein,
said second agent is an essential oil, wherein said essential oil is selected from the group consisting of citronella oil, geranium oil, and Amyris oil;
said pyrethrum is present in said arthropod control composition at a concentration of about 1 μg/cm², 30 μg/cm², or 100 μg/cm²; and, said second agent is present in said arthropod control composition at a concentration of about 100 ug/cm².
   17b. The arthropod control composition of embodiment 13a, wherein said essential oil is selected from the group consisting of Cedarwood Virginian, dill seed oil, fennel oil, fir needle oil, and parsley, wherein said essential oil is present in said arthropod control composition at a concentration of about 2 μg/insect.
   17c. The arthropod control composition of embodiment 13a, wherein said essential oil is selected from the group consisting of Amyris oil, Balsam Copaiba, Cedarwood Texas, Cedarwood Virginian, dill seed oil, fennel oil, fir needle oil, and Nutmeg EI, wherein said essential oil is present in said arthropod control composition at a concentration of about 2 μg/insect.
   17d. The arthropod control composition of embodiment 13a, wherein said essential oil is selected from the group consisting of cade oil, cardamom, Cedarwood Virginian, cypress, dill weed oil, fir needle oil, guaiacwood, wherein said essential oil is present in said arthropod control composition at a concentration of about 100 μg/insect.
   17e. The arthropod control composition of embodiment 13a, wherein said essential oil is selected from the group consisting of Amyris oil, Balsam Copaiba, Cardamom, cedarleaf, Cedarwood Texas, Cedarwood Virginian, Cypress, dill seed oil, dill weed, fennel oil, ginger root, nutmeg EI, and parsley, wherein said essential oil is present in said arthropod control composition at a concentration of about 100 μg/insect.
   17f. The arthropod control composition of any one of embodiments 17b-17e, wherein said pyrethrum is present in said arthropod control composition at a concentration of about 0.55 ng/mg insect.
   17g. The arthropod control composition of any one of embodiments 1-17e, wherein said composition is capable of causing knockdown of an arthropod within one hour of exposure to said composition.
   17h. The arthropod control composition of any one of embodiments 1-17e, wherein said composition is capable of causing mortality to an arthropod within twenty-four hours of exposure to said composition.
   18a. A method of providing a composition in an arthropod repellent medium from which a vaporized composition can be dispersed, wherein said composition comprises pyrethrum and a second agent selected from the group consisting of:
i. a compound of Formula I

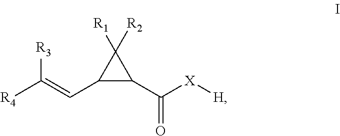

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
wherein said composition is synergistic, in admixture with a carrier.
   18b. The method of embodiment 18a, wherein said arthropod is a fly, spider, butterfly, moth, crab, mosquito, centipede, tick, millipede, biting midge, bedbug, kissing bug, Varroa mite, dust mite, or scorpion.
   18c. The method of any one of embodiments 18a-18b, wherein said arthropod is a mosquito.
   18d. The method of any one of embodiments 18a-18c, where said object or locus is an area, an environment, or the skin of an animal.
   18e. The method of any one of embodiments 18a-18d, wherein said pyrethrum is present at a concentration of about 0.01 μg/cm² to about 10,000 μg/cm², and said second agent is present at a concentration of about 0.01 μg/cm² to about 50,000 μg/cm².
   18f. The method of any one of embodiments 18a-18e, wherein said second agent is a compound of Formula I.
   18g. The method of one of embodiments 18a-18f, wherein X is O.
   18h. The method of one of embodiments 18a-18g, wherein R₁ and R₂ are each methyl.
   18i. The method of one of embodiments 18a-18h, wherein R₃ and R₄ are each independently selected from the group consisting of C₁₋C₃ alkyl and halo.
   18j. The method of one of embodiments 18a-18i, wherein R₃ and R₄ are each independently methyl.
   18k. The method of one of embodiment 18a-18j, wherein said compound of Formula I is

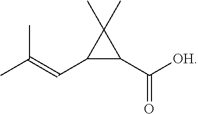

18l. The method of embodiment 18a, wherein,
said second agent is a compound of Formula I, wherein said compound is

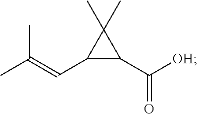

said pyrethrum is present in said composition at a concentration of about 0.01 μg/cm² to about 10,000 μg/cm²; and
said second agent is present in said composition at a concentration of about 0.1 μg/cm² to about 1,000 μg/cm².
   18ll. The method of claim 18l, wherein said pyrethrum is present in said composition at a concentration of about 1 μg/cm², 30 μg/cm², or 100 μg/cm²; and, said second agent is present in said composition at a concentration of about 10 μg/cm².
   18m. The method of any one of embodiments 18a-18i, wherein R₃ and R₄ are each independently chloro.
   18n. The method of any one of embodiments 18a-18i or 18n, wherein said compound of Formula I is

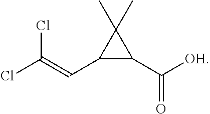

18o. The method of embodiment 18a, wherein,
said second agent is a compound of Formula I, wherein said compound is

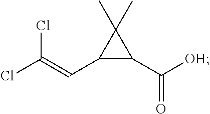

said pyrethrum is present in said composition at a concentration of about 0.01 μg/cm² to about 10,000 μg/cm²; and,
said second agent is present in said composition at a concentration of about 0.5 μg/cm² to about 5,000 μg/cm².
   18oo. The method of claim 18l, wherein said pyrethrum is present in said composition at a concentration of about 1 μg/cm², 30 μg/cm², or 100 μg/cm²; and, said second agent is present in said composition at a concentration of about 50 μg/cm².
   18p. The method of any one of embodiments 18a-18e, wherein said second agent is an essential oil.
   18pp. The method of embodiment 18p, wherein said essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil.
   18q. The method of embodiment 18p or 18pp, wherein said essential oil is selected from the group consisting of citronella oil, Amyris oil, dill seed oil, galbanum oil, cade oil, ginger root oil, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam, nutmeg oil, fennel oil, dill weed oil, balsam copaiba, and tea tree oil.
   18r. The method of embodiment 18p, 18pp, or 18q, wherein said essential oil is selected from the group consisting of citronella oil, geranium oil, and Amyris oil.
   18s. The method of any one of embodiments 18pp or 18p-18r, wherein said essential oil is citronella oil.
   18t. The method embodiment 18a, wherein,
said second agent is an essential oil, wherein said essential oil is selected from the group consisting of citronella oil, geranium oil, and Amyris oil;
said pyrethrum is present in said composition at a concentration of about 0.01 μg/cm² to about 10,000 μg/cm²; and,
said essential oil is present in said composition at a concentration of about 1 μg/cm² to about 10,000 μg/cm².
   18tt. The method of claim 18t, wherein said pyrethrum is present in said composition at a concentration of about 1 μg/cm², 30 μg/cm², or 100 μg/cm²; and, said second agent is present in said composition at a concentration of about 100 μg/cm².
   18u. The method of any one of embodiments 18a-18u, wherein said composition is formulated for use in a vaporizer, evaporator, fan, heat, candle, or wicked apparatus.
   18v. The method of any one of embodiments 18a-18u, wherein said composition is a vapor.
   19. A method of repelling an arthropod from an object or locus, comprising contacting said object or locus with a composition comprising pyrethrum and a second agent selected from the group consisting of:
i. a compound of Formula I

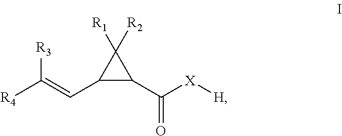

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
   wherein,
said composition is synergistic, in admixture with a carrier; and,
said arthropod is repelled from an adjacent area to said object or locus and is not physically contacted with said object or locus.
   20. The method of embodiment 19, wherein said arthropod is a fly, spider, butterfly, moth, crab, mosquito, centipede, tick, millipede, biting midge, bedbug, kissing bug, Varroa mite, dust mite, or scorpion.
   21. The method of embodiment 19 or 20, wherein said arthropod is a mosquito.
   22. The method of any one of embodiments 19-21, where said object or locus is an area, an environment, or the skin of an animal.
   22a. The method of any one of embodiments of 19-22, wherein said pyrethrum is present at a concentration of about 0.01 μg/cm² to about 10,000 μg/cm², and said second agent is present at a concentration of about 0.01 μg/cm² to about 50,000 μg/cm².
   23. The method of any one of embodiments 19-22, wherein said second agent is a compound of Formula I.
   24. The method of any one of embodiments 19-23, wherein X is O.
   25. The method of any one of embodiments 19-24, wherein R₁ and R₂ are each methyl.
   26. The method of any one of embodiments 19-25, wherein R₃ and R₄ are each independently selected from the group consisting of C₁₋C₃ alkyl and halo.
   27. The method of any one of embodiments 19-26, wherein R₃ and R₄ are each independently methyl.
   28. The method of any one of embodiments 19-27, wherein said compound of Formula I is

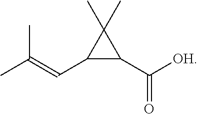

29. The method of embodiment 19, wherein,
said second agent is a compound of Formula I, wherein said compound is

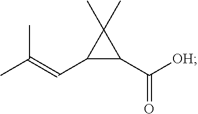

said pyrethrum is present in said composition at a concentration of about 0.01 μg/cm² to about 10,000 μg/cm²; and
said second agent is present in said composition at a concentration of about 0.1 μg/cm² to about 1,000 μg/cm².
   29a. The method of claim 29, wherein said pyrethrum is present in said composition at a concentration of about 1 μg/cm², 30 μg/cm², or 100 μg/cm²; and, said second agent is present in said composition at a concentration of about 10 μg/cm².
   30. The method of any one of embodiments 19-26, wherein R₃ and R₄ are each independently chloro.
   31. The method of embodiment 30, wherein said compound of Formula I is

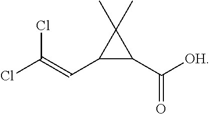

32. The method of embodiment 19, wherein,
said second agent is a compound of Formula I, wherein said compound is

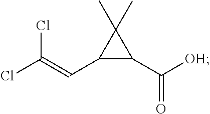

said pyrethrum is present in said composition at a concentration of about 0.01 μg/cm² to about 10,000 μg/cm²; and,
said second agent is present in said composition at a concentration of about 0.5 μg/cm² to about 5,000 μg/cm².
   32a. The method of claim 32, wherein said pyrethrum is present in said composition at a concentration of about 1 μg/cm², 30 μg/cm², or 100 μg/cm²; and, said second agent is present in said composition at a concentration of about 50 μg/cm².
   33. The method of any one of embodiments 19-22, wherein said second agent is an essential oil.
   33a. The method of embodiment 33, wherein said essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil.
   34. The method of embodiment 33 or 33a, wherein said essential oil is selected from the group consisting of citronella oil, Amyris oil, dill seed oil, galbanum oil, cade oil, ginger root oil, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam, nutmeg oil, fennel oil, dill weed oil, balsam copaiba, and tea tree oil.
   35. The method of embodiment 33 or 34, wherein said essential oil is selected from the group consisting of citronella oil, geranium oil, and Amyris oil.
   36. The method of any one of embodiments 33-35, wherein said essential oil is citronella oil.
   37. The method embodiment 19, wherein,
said second agent is an essential oil, wherein said essential oil is selected from the group consisting of citronella oil, geranium oil, and Amyris oil;
said pyrethrum is present in said composition at a concentration of about 0.01 μg/cm² to about 10,000 μg/cm²; and,
said essential oil is present in said composition at a concentration of about 1 μg/cm² to about 10,000 μg/cm².
   37a. The method of claim 37, wherein said pyrethrum is present in said composition at a concentration of about 1 μg/cm², 30 μg/cm², or 100 μg/cm²; and, said essential oil is present in said composition at a concentration of about 100 μg/cm².
   38. The method of any one of embodiments 19-38, wherein said composition is formulated for use in a vaporizer, evaporator, fan, heat, candle, or wicked apparatus.
   39. The method of any one of embodiments 19-38, wherein said composition is a vapor.
   40. A method for controlling one or more arthropods, comprising contacting an object or locus adjacent to said one or more arthropods with a composition comprising pyrethrum and a second agent selected from the group consisting of:
i. a compound of Formula I

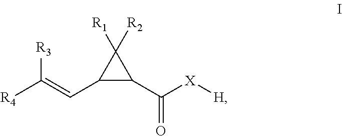

wherein,
   R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
   R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
   R₁ and R₂ are each independently selected from hydrogen, haloalkyl, alkenyl, alkynyl, and C₁₋C₆ alkyl; and
   X is selected from the group consisting of O, NH, and S;
      and
ii. an essential oil,
   wherein,
said composition is synergistic, in admixture with a carrier; and,
wherein said one or more arthropods are not physically contacted with said object or locus.
   41. The method of embodiment 40, wherein said one are more arthropods are flies, spiders, butterflies, moths, crabs, mosquitoes, centipedes, ticks, millipedes, biting midges, bedbugs, kissing bugs, Varroa mites, dust mites, or scorpions.
   42. The method of embodiment 40 or 41, wherein said one or more arthropods are mosquitoes.
   43. The method of any one of embodiments 40-42, where said object or locus is an area, an environment, or the skin of an animal.
   43a. The method of any one of embodiments 40-43, wherein said pyrethrum is present at a concentration of about 0.01 μg/cm² to about 10,000 μg/cm², and said second agent is present at a concentration of about 0.01 μg/cm² to about 50,000 μg/cm².
   44. The method of any one of embodiments 40-44, wherein said second agent is a compound of Formula I.
   45. The method of any one of embodiments 40-44, wherein X is O.
   46. The method of any one of embodiments 40-45, wherein R₁ and R₂ are each methyl.
   47. The method of any one of embodiments 40-46, wherein R₃ and R₄ are each independently selected from the group consisting of C₁₋C₃ alkyl and halo.
   48. The method of any one of embodiments 40-47, wherein R₃ and R₄ are each independently methyl.
   49. The method of embodiment 48, wherein said compound of Formula I is

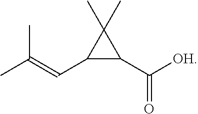

50. The method of embodiment 40, wherein,
said second agent is a compound of Formula I, wherein said compound is

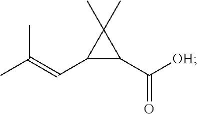

said pyrethrum is present in said composition at a concentration of about 0.01 μg/cm² to about 10,000 μg/cm²; and
said second agent is present in said composition at a concentration of about 0.1 μg/cm² to about 1,000 μg/cm².
   50a. The method of claim 50, wherein said pyrethrum is present in said composition at a concentration of about 1 μg/cm², 30 μg/cm², or 100 μg/cm²; and, said second agent is present in said composition at a concentration of about 10 μg/cm².
   51. The method of any one of embodiments 40-47, wherein R₃ and R₄ are each independently chloro.
   52. The method of embodiment 51, wherein said compound of Formula I is

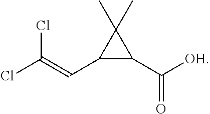

53. The method of embodiment 40, wherein,
said second agent is a compound of Formula I, wherein said compound is

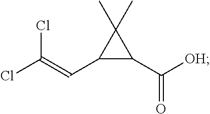

said pyrethrum is present in said composition at a concentration of about 0.01 μg/cm² to about 10,000 μg/cm²; and,
said second agent is present in said composition at a concentration of about 0.5 μg/cm² to about 5,000 μg/cm².
   53a. The method of claim 53, wherein said pyrethrum is present in said composition at a concentration of about 1 μg/cm², 30 μg/cm², or 100 μg/cm²; and, said second agent is present in said composition at a concentration of about 50 μg/cm².
   54. The method of any one of embodiments 40-43, wherein said second agent is an essential oil.
   54a. The method of embodiment 54, wherein said essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil.
   55. The method of embodiment 54 or 54a, wherein said essential oil is selected from the group consisting of citronella oil, Amyris oil, dill seed oil, galbanum oil, cade oil, ginger root oil, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam, nutmeg oil, fennel oil, dill weed oil, balsam copaiba, and tea tree oil.
   56. The method of embodiment 54, 54a, or 55, wherein said essential oil is selected from the group consisting of citronella oil, geranium oil, and Amyris oil.
   57. The method of any one of embodiments 54, or 54a-56, wherein said essential oil is citronella oil.
   58. The method embodiment 40, wherein,
said second agent is an essential oil, wherein said essential oil is selected from the group consisting of citronella oil, geranium oil, and Amyris oil;
said pyrethrum is present in said composition at a concentration of about 0.01 μg/cm² to about 10,000 μg/cm²; and,
said essential oil is present in said composition at a concentration of about 1 μg/cm² to about 10,000 μg/cm².
   58a. The method of claim 58, wherein said pyrethrum is present in said composition at a concentration of about 1 μg/cm², 30 μg/cm², or 100 μg/cm²; and, said essential oil is present in said composition at a concentration of about 100 μg/cm².
   59. The method of any one of embodiments 40-58, wherein said composition is formulated for use in a vaporizer, evaporator, fan, heat, candle, or wicked apparatus.
   60. The method of any one of embodiments 40-59, wherein said composition is a vapor.
   61. A method of repelling a species of arthropod from a locus, comprising contacting on said locus the arthropod control composition of any one of embodiments 1-17g.
   62. A method for controlling one or more arthropods, comprising contacting said one or more arthropods with the arthropod control composition of any one of embodiments 1-17g.
   63. The method of embodiment 62, wherein said one or more arthropods experiences knockdown within one hour of exposure to said composition.
   64. The method of embodiment 62, wherein said one or more arthropods reaches its mortality within twenty-four hours of exposure to said composition.

The following examples are offered by way of illustration and not by way of limitation.

### EXAMPLES

### Vapor Toxicity Experiments

The pyrethrum was a liquid, which was dissolved in a solvent and applied to a filter paper as described below in the assay information. The essential oils, TFA, TCA, and other materials used in the examples below were purchased from commercial suppliers.

The synergist ratios were defined as follows: SR=LC₅₀ NP÷LC₅₀ NP+synergist. Synergist ratios equal to or greater than 2 denote synergism, while ratios equal to or less than 0.5 denote antagonism. Ratios between 2 and 0.5 indicate no real effect.

The following assay, which was conducted according to the procedures of Jiang et al., 2019 (Jiang S., Yang L, and Bloomquist J, 2019) High-throughput screening method for evaluating spatial repellency and vapor toxicity to mosquitoes, Med. Vet. Entomol.) describes how the procedures in the following examples were conducted.

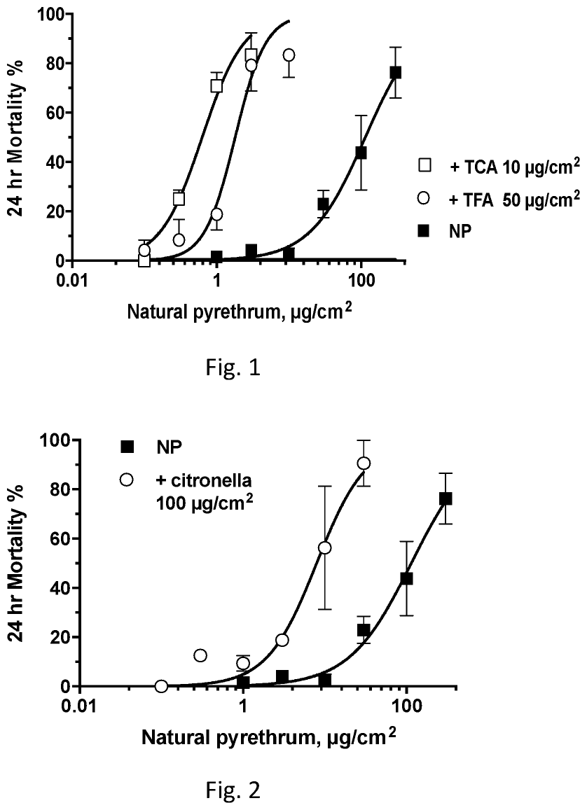

For assessing behavioral repellency (FIG. 1), sixteen female Aedes aegypti mosquitoes were transferred to a glass tube (12.5 cm long, 2.5 cm outer diameter) with the ends covered with netting. DEET was used as a control in the experiments. Pyrethrum, TFA, TCA, and the essential oils were dissolved in 1 mL of acetone and serial dilutions ranging from 30-0.01 μg/ml were made. Circular filter papers (5 cm²) were saturated with 50 μL of each concentration and allowed 10 min for solvent evaporation. The filter papers were then placed in clear conical polypropylene caps and fixed to the end of the glass tubes. The netting prevented mosquito contact with the filter paper, so exposure only occurred from pyrethrum that evaporated off the filter paper and diffused into the tube. Tubes were then aligned with a mark denoting the midline and the proportion of mosquitoes on the chemically treated side was scored at 15, 30, and 60 min. At the end of the test, the tube was placed in a cage and the ability of the mosquitoes to fly out of the tube was assessed for 30 min. For controls, after a 60 min observation period, all the mosquitoes left the tube within 10 min. This post-test evaluated whether any non-responding mosquitoes (not repelled) was due to intoxication or disorientation from the test chemical. For vapor toxicity (i.e. mortality), the assay was identical, except that mosquitoes were kept in the tube for 24 hr without the post-test at 1 hr, and the mortality was recorded at 24 hr (FIG. 4)

### Example 1: Synergism of Vapor Toxicity of Natural Pyrethrins by 1R-trans-chrysanthemic Acid (TCA) and (1R,3S)-3-(2,2-dichloroethenyl)-2,2-dimethylcyclopropanecarboxylic Acid (TFA)

The vapor toxicity of natural pyrethrins was synergized by 1R-trans-chrysanthemic acid (TCA) and (1R,3S)-3-(2,2-dichloroethenyl)-2,2-dimethylcyclopropanecarboxylic acid (TFA) (FIG. 1). Significant synergism was observed by both agents. The synergist ratio was defined as SR=LC₅₀ NP÷LC₅₀ NP+synergist. As shown in FIG. 1, the natural pyrethrins were tested in a range of concentrations. Both TCA and TFA were individually screened at sublethal concentrations, and produced no toxicity by themselves at the concentrations used in the mixtures. Results are provided in Table 1:

TABLE 1

| Treatment | LC₅₀ | Slope | SR |
|---|---|---|---|
| Natural pyrethrins (NP) | 114 | 1.1 | |
| NP + TCA 10 μg/cm² | 0.6 | 1.5 | 190 |
| NP + TFA 50 μg/cm² | 1.8 | 2.1 | 63.3 |

### Example 2: Synergism of Vapor Toxicity of Natural Pyrethrins by Citronella

The vapor toxicity of natural pyrethrins was synergized by citronella (FIG. 2). The synergist ratio was defined as SR=LC₅₀ NP÷LC₅₀ NP+synergist. As shown in FIG. 2, the natural pyrethrins were tested in a range of concentrations. The LC₅₀ of citronella oil was found to be 204 μg/cm². Results are provided in Table 2.

TABLE 2

| Treatment | LC₅₀ | Slope | SR |
|---|---|---|---|
| Natural pyrethrins (NP) | 114 | 1.1 | |
| NP + citronella oil 100 μg/cm² | 8.2 | 1.2 | 13.9 |

### Example 3: Synergism of Vapor Toxicity of Natural Pyrethrins by Plant Essential Oils

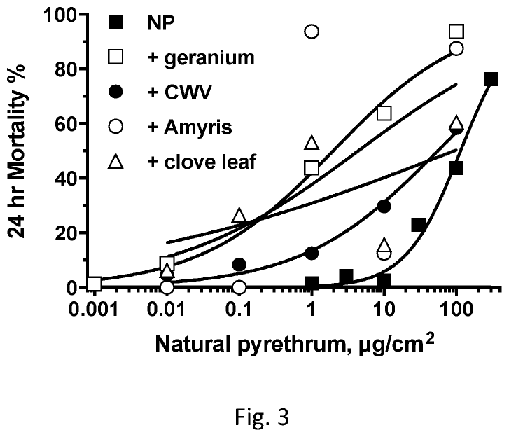

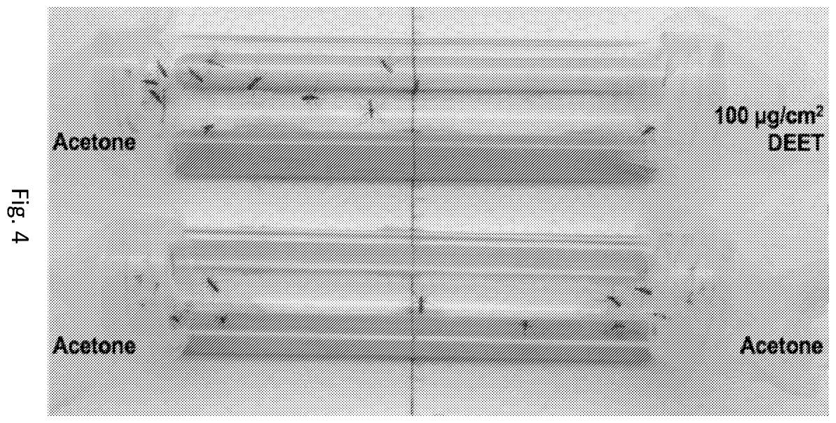

The vapor toxicity of natural pyrethrins was synergized by various plant essential oils. In particular, geranium, CWV (Cedarwood Oil Virginiana), Amyris, and clove leaf oil were investigated, all of which were applied at 100 μg/cm² (FIG. 3). The synergist ratio was defined as SR=LC₅₀ NP÷LC₅₀ NP+synergist. As shown in FIG. 3, the natural pyrethrins were tested in a range of concentrations. The LC₅₀ of geranium oil was 161 μg/cm². The LC₅₀ of Cedarwood Oil Virginiana was 977 μg/cm². The LC₅₀ of amyris oil was 4000 μg/cm². The LC₅₀ of clove leaf oil was 375 μg/cm². Results are provided in Table 3.

TABLE 3

| Treatment | LC₅₀ | Slope | SR |
|---|---|---|---|
| Natural pyrethrins (NP) | 114 | 1.1 | |
| NP + geranium 100 μg/cm² | 0.76 | 1.2 | 150 |
| NP + CWV 100 μg/cm² | 92 | 0.34 | 1.2 |
| NP + Amyris 100 μg/cm² | 4.4 | 0.34 | 26 |
| NP + clove leaf 100 μg/cm² | 93 | 0.18 | 1.2 |

### Topical Toxicity Experiments

Chemicals

Plant essential oils were obtained from Berje, Inc. (Carteret, NJ, USA). Natural pyrethrins were obtained from Fairfield American Corp. (Newark, NJ, USA). Pure ethanol (100%) was used as a vehicle for plant oils and natural pyrethrins and was obtained from Sigma Aldrich (St. Louis, MO, USA). Piperonyl butoxide (PBO) (>95%) was also obtained from Sigma Aldrich (St. Louis, MO). Sucrose for sugar water was obtained from Domino (Baltimore, MD, USA).

Insects

Orlando strain Aedes aegypti females were reared according to standard procedures utilized by the United States Department of Agriculture (USDA) (Pridgeon, J. W.; et al. Structure-activity relationships of 33 piperidines as toxicants against female adults of Aedes aegypti (Diptera: Culicidae). J. Med Entomol. 2007, 44, 263-269). Pupae were provided by the USDA prior to experiments. Pupae were allowed to eclose in 20.3×20.3×20.3 cm cages (Bioquip, Inc., Rancho Dominguez, CA, USA) and provided 10% sucrose water ad libitum prior to experiments. Mosquitoes were kept in incubators (Darwin Chambers, St. Louis, MO, USA) maintained at 28° C.±75% humidity with a 12:12 light dark cycle. Only nonblood-fed adult females were used for each experiment, and treated individuals ranged from 2-7 days old (Jiang, S.; Yang, L.; Bloomquist, J. R. High-throughput screening method for evaluating spatial repellency and vapour toxicity to mosquitoes. Med. Vet. Entomol. 2019, 33, 388-396).

Topical Application

Topical applications of ethanolic solutions containing natural pyrethrins and/or essential oils were performed using methods similar to those outlined in Norris, E. J.; et al. Comparison of the Insecticidal Characteristics of Commercially Available Plant Essential Oils Against Aedes aegypti and Anopheles gambiae (Diptera: Culicidae). J. Med. Entomol. 2015, 52, 993-1002. Concentrations of natural pyrethrins ranged from those producing 10% to 90% mortality to ensure a good fit for probit models and to accurately calculate LD₂₅ and LD₅₀ values. Plant essential oils were applied at either 2 μg/insect or 10 μg/insect alone or in combination with the approximate LD₂₅ of natural pyrethrins. The LD₂₅ (1.6 ng/mosquito) was calculated using a Probit model and given as a discrete dose assuming the weight of female mosquitoes was 2.85±0.08 mg/mosquito (average from five cohorts with SEM). Topical applications were performed by anesthetizing adult female mosquitoes on ice for 5 min, and then placing them on a cold, glass Petri dish to prevent reanimation. A Whatman No. 2 filter paper was used to prevent mosquitoes from coming in contact with excess condensation. A 0.2 μL volume of each treatment was applied to the pronotum of each mosquito using a Hamilton (Reno, NV, USA) repeating applicator with a gastight Hamilton syringe and placed in 470 mL deli paper cups. At least five concentrations were used to obtain LD₂₅ and LD₅₀ values for natural pyrethrins alone or in combination with select oils. Ten mosquitoes were treated for each concentration representing one replicate, and at least three different cohorts of mosquitoes were used for each concentration in an effort to control for biological variability in the mosquitoes produced by the Orlando colony. A cohort was defined as a distinct rearing group (i.e., adult mosquitoes obtained from distinct batches of eggs placed in water to initiate development each week). Controls were performed using the vehicle, ethanol. Tulle fabric, fastened to the cup with a deli cup lid rim (center removed), was used to keep mosquitoes from escaping. Deli cups containing ten treated mosquitoes per concentration per replicate were placed in an incubator for the remainder of the experimental interval and kept at the same temperature and light cycle as during rearing. Knockdown, defined as the inability to fly or maintain normal standing posture, was recorded at 1 h, and mortality was recorded at 24 h. Mortality was defined as no movement, even after gently tapping the cup several times to assess response.

Data Analysis

To assess synergism, the co-toxicity factor method was utilized (Mansour, N. A.; et al. Toxicological studies on the Egyptian cotton leafworm, Prodenia litura. VI. Potentiation and antagonism of organophosphorus and carbamate insecticides. Econ. Entomol. 1966, 59, 307-311. In short, percentage knockdown and mortality were recorded for all treatments of plant essential oils alone, natural pyrethrins alone, and combinations thereof, and co-toxicity factors were calculated using the following equation:

$$Co ‐ toxicity Factor = \frac{Observed Mortality - Expected Mortality}{Expected Mortality} \times 100$$

In this equation, observed mortality was the toxicity observed experimentally in combinations of plant oils and natural pyrethrins at either specific dose of plant essential oils (2 and 10 μg/insect). Expected mortality was the additive sum of the observed mortality for natural pyrethrins alone and each plant essential oil alone. Values >20 represent synergistic mixtures, −20≤values≤20 represent additive mixtures and values <−20 represent mixtures that are antagonistic. An LD₂₅ of natural pyrethrins was used alone or in combination with discrete doses of plant essential oils to calculate co-toxicity values. LD₅₀ and LD₂₅ values for natural pyrethrins were derived from Probit analysis (Finney et al. 1952 (Finney, D. J. Probit Analysis: A Statistical Treatment of the Sigmoid Response Curve, 2nd ed.; Cambridge University Press: Cambridge, UK, 1952)), using a PROC Probit calculation with a control correction option (OPTC) (to account for control mortality) performed in SAS 9.4 (SAS Institute, Inc., Cary, NC, USA). After synergistic combinations were identified using the co-toxicity factor method, conventional synergism ratios (LD₅₀ of natural pyrethrins alone÷LD₅₀ of natural pyrethrins+a sublethal dose of essential oil) were calculated to evaluate the degree of synergism produced. These experiments were done for comparison and to further evaluate the performance of the co-toxicity factor method outlined by Mansour et al. 1966 (Mansour, N. A.; et al. Toxicological studies on the Egyptian cotton leafworm, Prodenia litura. VI. Potentiation and antagonism of organophosphorus and carbamate insecticides. Econ. Entomol. 1966, 59, 307-311). To compare effects at discrete doses to one another or between those and control, an ANOVA (α=0.05) with a Tukey's post-test was used with an α value of 0.05. For synergism assessments at discrete doses of plant essential oils, natural pyrethrins were applied in every cohort to obtain a relevant percentage mortality for the LD₂₅ of natural pyrethrins for each cohort. As the response to natural pyrethrins differed slightly in every cohort, this approach ensured that cohort bias was accounted for in all comparisons in the analysis. As a result, the responses for natural pyrethrins alone and plant essential oils alone were adequately taken into account in the co-toxicity calculations for each combination of oil and natural pyrethrins using the aforementioned equation.

Results

Overall, plant essential oils exhibited a spectrum of activity when applied both alone and in combination with natural pyrethrins. Unique differences were observed in knockdown at 1 h and mortality at 24 h for each essential oil. At 2 (Table 4) and 10 μg/insect (Table 5), a majority of oils did not produce any effects significantly different from the control when applied alone. Only balsam (Peru) produced significant knockdown at 2 μg/insect compared to the control (Table 4), but the overall mean level of knockdown was low; 20±5.8% at 1 h (mean+SEM). Moreover, at the 2 μg/insect dose, no oils produced significant mortality compared to the control, but at 10 μg/insect (Table 5), more plant essential oils caused significant knockdown and mortality compared to the ethanol control. Piperonyl butoxide (PBO), Amyris, balsam (Peru), cypress, and guaiacwood all produced significant 1 h knockdown, and among these, balsam (Peru) (73.3±12%) produced the highest levels of 1 h knockdown at this screening concentration. Piperonyl butoxide (PBO), Amyris, Canadian balsam fir, citronella, and guaiacwood all produced statistically significant mortality compared to the ethanol control at 24 h when applied at 10 μg/insect; however, only PBO, Canadian balsam fir, and guaiacwood produced mortality that was greater than 50% (Table 5).

In order to screen for synergistic interactions between natural pyrethrins and plant essential oils, the essential oils were applied with a calculated LD₂₅ of natural pyrethrins. The theoretical LD₂₅ and LD₅₀ for natural pyrethrins were calculated to be 0.55 ng/mg insect and 1.53 ng/mg insect, respectively. As the weight for each mosquito cohort varied, a discrete dose of (1.6 ng/insect) was applied, assuming mosquitoes in each cohort weighed 2.85 mg/mosquito (average of five cohorts of mosquitoes). The theoretical LD₂₅ produced 14±1.9% mortality at 24 h when averaged across all replicates. The range of average mortality for all cohorts (groups of three or more replicates associated with selected plant essential oils within each group) was 6.6-22% mortality. As mortality produced by the theoretical dose was lower than expected (i.e., below 25%), the co-toxicity factors were calculated using the actual percentage mortality produced by natural pyrethrins within each cohort to avoid cohort biases.

TABLE 4
Percentage 1 h knockdown and 24 h mortality values for natural pyrethrins (LD₂₅), plant
essential oils or PBO synergists (2 μg/insect), mixture of natural pyrethrins + synergist,
and the calculated co-toxicity factors for each mixture.

| | 1 h % Knockdown ± SE | | | | 24 h % Mortality ± SE | | | |
|---|---|---|---|---|---|---|---|---|
| Essential | Natural | | | Co-toxicity | Natural | | | Co-Toxicity |
| Oil/Compound | Pyrethrins | Synergist | Mixture | Factor | Pyrethrins | Synergist | Mixture | Factor |
| Control (ethanol) | NA | 0.6 ± 0.6 | NA | NA | NA | 1. [symbol] ± 1 | NA | NA |
| PBO | 46.7 ± 3.7 | 6.7 ± 3.7 | 10 ± 3.7 | − [symbol] 1.2 ** | 8.9 ± [symbol] .3 | 6.7 ± 2.4 | 26.7 ± 3.7 | 71.2 |
| Amyris | 48.5 ± [symbol] .1 | 6.7 ± 3.3 | 63.3 ± 21.9 | 14.7 | 11.4 ± 2.6 | 3.3 ± 3.3 | [symbol] .3 ± 8.8 | 127 |
| Balsam Copaiba | 50 ± 5.8 | 2.5 ± 2.5 | 32.5 ± 4.8 | −38.1 ** | 13.8 ± 3.7 | 2.5 ± 2.5 | 25 ± 2.9 | 53.4 |
| Balsam Peru | 5 [symbol] ± 8 | 20 ± 5.8* | 60 ± 10 | −23 ** | 18 ± [symbol] | 10 ± 10 | 26.7 ± 12 | −4.6 |
| Cade | 23.3 ± 6.6 | 6.6 ± 6.6 | 23.3 ± 18.6 | −22.1 ** | 6.6 ± 3.3 | 10 ± [symbol] | 3.3 ± 3.3 | − [symbol] .1 ** |
| Canadian Balsam Fir | [symbol] ± 5.8 | 15 ± 8.8 | 20 ± 0 | −63.6 ** | 13.3 ± [symbol] | 20 ± 0 | 23.3 ± [symbol] .3 | −21 ** |
| Cardamom | 60 ± 5.8 | 0 ± 0 | 60 ± 5.8 | 0 | 20 ± 10 | 0 ± 0 | 10 ± 10 | −30 ** |
| Cedarleaf | 58 ± 8 | 3.3 ± 3.3 | 56.7 ± 3.3 | −7.3 | [symbol] ± 5.8 | 13.3 ± 5.8 | 36.7 ± 8.8 | 17.3 |
| Cedarwood Texas | 47.8 ± 4.9 | 4 ± 2.4 | 44 ± 9.3 | −15.1 | 14.4 ± 5.3 | 14 ± 7.5 | 50 ± 8.9 | 76.1 |
| Cedarwood Virginian | 36 ± 4 | 0 ± 0 | 63.3 ± 8.8 | 75. [symbol] | 18 ± 9.2 | 6 ± 4 | 30 ± 7.1 | 25 |
| Citronella | 29 ± 3 | 1. [symbol] ± 1. [symbol] | 18.6 ± 2.7 | −39.2 ** | 29.3 ± 2.8 | 4 ± 4 | 29.3 ± [symbol] .5 | −13.1 |
| Cypress | 50 ± 4.5 | 5 ± 5 | 62.5 ± 15.5 | 1 [symbol] .6 | 13.3 ± 2.1 | 5 ± 5 | 12.5 ± [symbol] .3 | −32.4 ** |
| Dillseed | 26.7 ± 3.3 | 0 ± 0 | 40 ± 17.3 | 49.8 | 6.7 ± 3.3 | 3.3 ± 3.3 | 16.6 ± 16.6 | 66 |
| Dillweed | 60 ± 5.8 | 6.7 ± 3.3 | [symbol] .3 ± 6.7 | −29 ** | 20 ± 10 | 10 ± 5.8 | 16.7 ± 3.3 | −44.3 ** |
| Fernel | 59 ± 5.8 | 2.5 ± 2.5 | 70 ± 9.1 | 33.3 | 17.8 ± 3.7 | 5 ± 5 | 25 ± 15 | 33 |
| Fir Needle Oil | 30 ± 5.8 | 0 ± 0 | 53.3 ± 18.6 | 77.6 | 20 ± 10 | 3.3 ± 3.3 | 30 ± 11. [symbol] | 28.8 |
| Galbanum | 40 ± 4. [symbol] | 2.5 ± 2.5 | 47.5 ± 11.1 | 11.5 | 12 ± 7.3 | 6 ± 6 | 4 ± 4 | −22.5 ** |
| Ginger Root | 40 ± 5.8 | 0 ± 0 | [symbol] 0 ± 10 | −2 [symbol] ** | 13.3 ± 5.8 | 13.3 ± [symbol] .8 | 13.3 ± 6.6 | −30 ** |
| Guaiacwood | 30 ± 0 | 10 ± 5.8 | 36.7 ± 13.3 | −8.25 | 6.6 ± 3.3 | 10 ± 9.8 | 16.7 ± 6.7 | 0 |
| Nutmeg EI | 47.1 ± 5.2 | [symbol] .3 ± 3. [symbol] | [symbol] 3.3 ± 6.6 | 5.8 | 10 ± 3.1 | 0 ± 0 | 40 ± 20 | [symbol] 0 |
| Parsley | 60 ± 5.8 | 6.7 ± 6.7 | 83.3 ± 6.6 | 21.9 | 20 ± 10 | 13.3 ± 3.3 | 26.7 ± 21.9 | −19.8 |

*denotes statistically significant percentage from the control via ANOVA (α = 0.05) with a Tukey's post-test; Bold numerals represent synergistic combinations; Numerals with two asterisks (**) represent antagonistic combinations. [symbol]
indicates data missing or illegible when filed

TABLE 5
Percentage 1 h knockdown and 24 h mortality values for natural pyrethrins (LD₂₅), plant essential oils or
piperonyl butoxide (PBO) synergists (10 μg/insect), mixture of natural pyrethrins + synergist, and the
calculated co-toxicity factors for each mixture.

| | 1 h % Knockdown ± SE | | | | 24 h % Mortality ± SE | | | |
|---|---|---|---|---|---|---|---|---|
| Essential | Natural | | | Co-toxicity | Natural | | | Co-Toxicity |
| Oil/Compound | Pyrethrins | Synergist | Mixture | Factor | Pyrethrins | Synergist | Mixture | Factor |
| Control (ethanol) | NA | 0.6 ± 0.6 | NA | NA | NA | 1.8 ± 1 | NA | NA |
| PBO | 46.7 ± 3.7 | 21.7 ± 4* | 21.7 ± 4.5 | −115 ** | 8.9 ± 3.3 | 65 ± [symbol] * | 80 ± 8.3 | 8.2 |
| Amyris | 48.5 ± 5.1 | 47.5 ± 13.8* | 57.5 ± 1 [symbol] .1 | − [symbol] ** | 11.4 ± 2.6 | 35 ± 16.6* | 70 ± 12.2 | 50.8 |
| Balsam Copaiba | 50 ± 5.8 | [symbol] ± 2.9 | 40 ± 4.1 | −27.3 ** | 13.8 ± 3.7 | 10 ± [symbol] .8 | 30 ± 26.3 | 26.1 |
| Balsam Peru | 58 ± 8 | 73.3 ± 12* | 76.7 ± 14.5 | −41.6 ** | 18 [symbol] 5.8 | 26.7 ± 8.8 | 4 [symbol] .3 ± [symbol] .8 | −9.2 |
| Cade | 23.3 ± 6.6 | 23.3 ± 13.3 | 36.7 ± [symbol] .3 | 21.7 | 6.6 ± 3.3 | 26.7 ± 12 | 30 ± 11.5 | −9.9 |
| Canadian Balsam Fir | 40 ± 6.8 | 25 ± [symbol] | [symbol] 0 ± 10 | − [symbol] .8 ** | 13.3 ± 8.8 | 70 ± 1 [symbol] .5* | 60 ± 10 | − [symbol] ** |
| Cardamom | 60 ± 5.8 | 0 ± 0 | 83.3 ± 8.8 | 38.8 | 20 ± 10 | 0 ± 0 | 40 ± 17.3 | 200 |
| Cedarleaf | 58 ± 8 | 6.7 ± 3.3 | 73.3 ± 6.6 | 13.3 | 18 ± 5.8 | 6.7 ± 3.3 | 50 ± 11.5 | 102 |
| Cedarwood Texas | 47.8 ± 4.9 | 8.3 ± 3.1 | 40 ± 6.8 | −28.7 ** | 14.4 ± 5.3 | 2 [symbol] .3 ± 10.5 | 55 ± 14.3 | 45.9 |
| Cedarwood Virginian | 36 ± 4 | 6.7 ± 3.3 | 66.7 ± 8.8 | 56.2 | 18 ± 9.2 | 18 ± 8.6 | 54 ± 12.9 | 50 |
| Citronella | 29 ± 3 | 4 ± 0 | 20 ± 4.6 | − [symbol] ** | 22 ± 7.2 | 37.3 ± 6.1* | 47.5 ± 6.3 | −19.9 |
| Cypress | [symbol] ± 4.5 | 10 ± 0* | 97.5 ± 2.5 | 62.5 | 13.3 ± 2.1 | [symbol] ± 2.9 | 22. [symbol] ± 6.3 | 21.6 |
| Dillseed | 26.7 ± 3.3 | 23.3 ± 3.3 | 43.3 ± 18.6 | −13.4 | 6.7 ± 3.3 | 13.3 ± 6.6 | 26. [symbol] ± 8.8 | 33.5 |
| Dillweed | 60 ± [symbol] .8 | 0 ± 0 | 76.7 ± 8.8 | 27.8 | 20 ± 10 | 0 ± 0 | [symbol] ± 6.7 | 66.5 |
| Fernel | 50 ± 5.8 | 10 ± 4.1 | 52.5 ± 2.5 | −12.5 | 1 [symbol] .8 ± 3.7 | 7.5 ± 2.5 | 30 ± 9.1 | 40.8 |
| Fir Needle Oil | 30 ± 5.8 | 3.3 ± 3.3 | 76.6 ± 8.8 | 130 | 20 ± 10 | 6.6 ± 6.6 | 30 ± 5.8 | 12.7 |
| Galbanum | 40 ± 4.5 | 7.5 ± 7.5 | 35 ± 14.4 | − [symbol] ** | 12 ± 7.3 | 12 ± 12 | 10 ± 5.5 | − [symbol] .3 ** |
| Ginger Root | 40 ± 5.8 | 10 ± 10 | 45 ± 5 | −10 | [symbol] ± 8.8 | 6.6 ± 3.3 | 33.3 ± 3.3 | 67.3 |
| Guaiacwood | 30 ± 0 | 43.3 ± 13.3* | 56.7 ± 12 | 22.6 | 6.6 ± 3.3 | 66.7 ± [symbol] * | 66.7 ± 8.8 | −9 |
| Nutmeg EI | 47.1 ± 5.2 | 7.5 ± 4. [symbol] | 57.5 ± [symbol] | 5.3 | 10 [symbol] 3.1 | 2.5 ± 2.5 | 2 [symbol] .5 ± 12.5 | 120 |
| Parsley | 60 ± [symbol] .8 | 23.3 ± 12 | 83.3 ± 8.8 | 0 | 20 [symbol] 10 | 3.3 ± 3.3 | 46.7 ± 12 | 100 |

*denotes statistically significant percentage from the control via ANOVA (α = 0.05) with a Tukey's post-test; Bold numerals represent synergistic combinations; Numerals with two asterisks (**) represent antagonistic combinations. [symbol]
indicates data missing or illegible when filed

Of the various oils, some produced synergism when applied with natural pyrethrins at 2 μg/insect, both of knockdown and mortality (Table 4). Cedarwood (Virginian), dillseed, fir needle oil, fennel, and parsley all produced knockdown co-toxicity factors greater than 20. In this assessment, fir needle oil performed the best with a knockdown co-toxicity factor of 77.6. This response was largely driven by the lack of knockdown produced by fir needle oil and the relatively high increase in knockdown for the mixture (53.3±18.6%). Many other oils increased the knockdown effects of natural pyrethrins, but these were essentially additive, producing co-toxicity factors between −20 and 20 (Table 4). A number of plant essential oils also antagonized knockdown at 1 h. PBO antagonized knockdown with only 10±3.7% knockdown observed in combinations of PBO and natural pyrethrins, whereas 47% knockdown was observed for natural pyrethrins alone. Of the oils, balsam (Copaiba), cade, Canadian balsam fir, dillweed, and ginger root all antagonized the quick immobilizing character of natural pyrethrins at 1 h, with co-toxicity factors less than −20. Of these, Canadian balsam fir was the most antagonistic (co-toxicity factor=−63.6). At the screening concentration of 2 μg/insect, numerous oils/agents synergized mortality. PBO, the commercial synergist standard used in this study, provided a high degree of synergism with a co-toxicity factor of 71 (Table 4). Amyris, balsam (Copaiba), cedarwood (Texas), cedarwood (Virginian), dillseed, fennel, fir needle oil, and nutmeg E.I. all produced synergism with co-toxicity factors greater than 20. Of these, nutmeg E.I. produced the largest co-toxicity factor (300). The other oils produced additive increases in mortality at 24 h, with the exception of cade, cardamom, cypress, dillweed, galbanum, and ginger root, which produced antagonistic co-toxicity factors (Table 4).

At the 10 μg/insect screening concentration, a number of oils synergized the 1 h knockdown and 24 h mortality produced by natural pyrethrins (Table 5). Cade, cardamom, cedarwood (Virginian), cypress, dillweed, fir needle, and guaiacwood oils synergized the knockdown of natural pyrethrins at 1 h, with fir needle oil being the most successful. Other oils either additively increased or antagonized 1 h knockdown. PBO strongly antagonized 1 h knockdown by natural pyrethrins at the 10 μg/insect concentration with a co-toxicity factor of −115, which was the most negative co-toxicity factor observed in this study. Among the oils, Amyris, balsam (Copaiba), balsam (Peru), Canadian balsam fir, cedarwood (Texas), and galbanum antagonized natural pyrethrins 1 h knockdown, whereas cedarleaf, dillseed, fennel, ginger root, nutmeg E.I., and parsley all additively increased 1 h knockdown of natural pyrethrins (Table 5). Many oils synergized natural pyrethrins mortality at 24 h at the 10 μg/insect concentration, whereas PBO did not. PBO instead produced high mortality when applied alone and the improvement of the combined mixture was minimal. Among the synergistic oils, Amyris, balsam (Copaiba), cardamom, cedarleaf, cedarwood (Texas), cedarwood (Virginian), dillseed, dillweed, fennel, ginger root, nutmeg E.I., and parsley, it was found that cardamom was the most active with a co-toxicity factor of 200. The remaining oils, with the exception of Canadian balsam fir and galbanum, increased the 24 h mortality of natural pyrethrins by an additive extent. Both Canadian balsam fir and galbanum antagonized the toxicity of natural pyrethrins at this concentration. Overall, the results in Tables 4 and 5 show that the synergistic potential of plant essential oils and PBO is concentration dependent.

To assess the utility and accuracy of the co-toxicity factor metric, a number of plant essential oils and PBO were screened (applied at a sublethal dose of 2 μg/insect) with variable concentrations of natural pyrethrins. The LD₅₀ values for natural pyrethrins in these experiments were then compared to the original LD₅₀ of natural pyrethrins to obtain a synergism ratio (Table 6). Of the oils screened in these follow-up studies, Amyris oil+natural pyrethrins produced the lowest LD₅₀ value (0.21 ng/mg mosquito) and the highest synergism ratio (7.3). Cedarwood (Texas) also produced significant synergism, but the synergism ratio for this formulation was 4, very similar to that produced by PBO (5.1). The other cedarwood oil, Virginian, also produced significant synergism with a synergism ratio of 3.6. Interestingly, both fir needle oil and citronella oil produced low levels of toxicity synergism, but these were not significant as indicated by T-test; p=0.59 for fir needle oil and p=0.74 for citronella. Slope values for natural pyrethrins were relatively unchanged by combined application with these plant essential oils.

TABLE 6
Dose-response statistics for natural pyrethrins applied alone and in combination
with select candidate synergists and their respective synergist ratios.

| | | LD₅₀ ng/mg Insect | | | | Synergism |
|---|---|---|---|---|---|---|
| Treatment | N | (95% CI) | | Slope (SE) | | Ratio * |
| Natural pyrethrins (NP) | 290 | 1.53 | (1.0-3.3) | 1.5 | (0.3) | — |
| NP + PBO | 210 | 0.3 | (0.19-0.44) | 2.0 | (0.53) | 5.1 * |
| NP + citronella | 150 | 1.13 | (0.7-5.2) | 1.7 | (0.49) | 1.4 |
| NP + Amyris | 150 | 0.21 | (0.13-0.3) | 2.0 | (0.3) | 7.3 * |
| NP + Cedarwood (Virginian) | 150 | 0.43 | (0.25-0.77) | 1.6 | (0.49) | 3.6 * |
| NP + Cedarwood (Texas) | 150 | 0.38 | (0.26-0.57) | 1.9 | (0.36) | 4 * |
| NP + fir needle off | 200 | 0.85 | (0.6-1.2) | 2.2 | (0.38) | 1.8 |

* denotes statistically significant percentage from the control (NP alone) via lack of overlap in 95% confidence intervals.

Discussion

Twenty plant essential oils were screened in combination with natural pyrethrins and knockdown at 1 h and mortality at 24 h were determined. Assessing enhancement of both knockdown and mortality are important considerations in the characterization of novel public health pest control formulations, as both effects may lead to the prevention of host feeding. Norris et al. proposed that knockdown of intoxicated mosquitoes may lead to higher levels of mortality over time in the field, due to exposure to fungal pathogens, desiccation or starvation through the inability to feed, and increased predation (Norris, E. J.; et al. Plant essential oils synergize various pyrethroid insecticides and antagonize malathion in Aedes aegypti. Med. Vet. Entomol. 2019, 33, 453-466). The results presented herein show that many plant essential oils not only improve the mortality produced by natural pyrethrins at 24 h, but also improve their speed-of-action.

In order to characterize the synergistic potential of plant essential oils, the plant essential oils were first screened alone to better understand their toxicological contributions in the mixtures. A wide range of toxicities were observed, with balsam (Peru) producing the most significant knockdown at 1 h at the 10 μg/insect concentration. In addition, a significant amount of recovery was observed in mosquitoes treated with this oil (73.3% knockdown at 1 h and 26.7% mortality at 24 h), indicating that metabolic processes probably detoxified the constituents within balsam (Peru) oil. Guaiacwood oil and Canadian balsam fir were the most toxic at 24 h, indicating their potential as natural insecticides. Norris et al. demonstrated that guaiacwood oil was predominantly composed of guaiol along with the minor constituent sesquiterpenoids, bulnesol, and bulnesene (Norris, E. J.; et al. Comparison of the Insecticidal Characteristics of Commercially Available Plant Essential Oils Against Aedes aegypti and Anopheles gambiae (Diptera: Culicidae). J. Med. Entomol. 2015, 52, 993-1002). Canadian balsam fir is predominantly composed of α-pinene, β-pinene, and phellandrene, any of which may be responsible for its toxicity (Ross, J.; et al. Chemical Composition of the Bark Oil of Balsam FirAbies balsamea(L.) Mill. J. Essent. Oil Res. 1996, 8, 343-346).

In contrast to the generally positive effects of essential oils on knockdown by natural pyrethrins, PBO significantly reduced knockdown by this natural insecticide. Norris et al. showed previously that PBO at both 2 and 10 μg/mosquito could significantly decrease the knockdown produced by select pyrethroids at 1 h post-application, and Kasai et al. showed that 1 hr pretreatment with PBO significantly decreased the penetration rate of [¹⁴C]-permethrin into Aedes aegypti females (Kasai S, et al. (2014) Mechanisms of Pyrethroid Resistance in the Dengue Mosquito Vector, Aedes aegypti: Target Site Insensitivity, Penetration, and Metabolism. PLoS Negl Trop Dis 8(6): e2948; and Norris et al., Insects 2018, 9, 132). These findings advise against combining diverse formulation additives simply due to their independent activity. The studies described herein corroborate the earlier findings that PBO significantly slowed the immobilization produced by natural pyrethrins in both the 2 μg and 10 μg/insect applications. Synergism of lethality was observed using the co-toxicity method, identifying oils that were synergistic with natural pyrethrins at the low dose application level (2 μg/insect), but not synergistic at the high dose level (10 μg/insect), oils that were synergistic at only the high dose level, those synergistic at both doses, and some that were not synergistic at either dose. This variety of responses was also true for antagonism. These findings demonstrate that synergist concentration is a useful consideration in the development of insecticidal mixtures. Unexpectedly, some oils and PBO were synergistic only at the low dose, but not at the high dose, which may result from sequestration of pyrethrins at the cuticular boundary. Moreover, it is possible that at the high dose, excess oil/PBO did not fully penetrate the insect cuticle. Of these oils, nutmeg E.I. produced the largest co-toxicity factor (Table 4), which is possibly due to the constituents safrole and myristicin, natural compounds that are structurally similar to PBO and contain an identical methylene-dioxyphenyl moiety (Kapoor, I. P. S.; Singh, B.; Singh, G.; De Heluani, C. S.; De Lampasona, M. P.; Catalan, C. A. N. Chemical Composition and Antioxidant Activity of Essential Oil and Oleoresins of Nutmeg (Myristica fragrans Houtt.) Fruits. Int. J. Food Properties 2013, 16, 1059-1070; and Philpot, R. M.; Hodgson, E. The production and modification of cytochrome P-450 difference spectra by in vivo administration of methylenedioxyphenyl compounds. Chem. Biol. Interact. 1971, 4, 185-194). Yang et al. 2015 demonstrated that myristicin was capable of inactivating human CYP1A2 (cytochrome P450 monooxygenase) via mechanism-based inhibition, similar to the action of PBO (Philpot, R. M.; Hodgson, E. The production and modification of cytochrome P-450 difference spectra by in vivo administration of methylenedioxyphenyl compounds. Chem. Biol. Interact. 1971, 4, 185-194; and Yang, A. H.; et al. Identification and characterization of reactive metabolites in myristicin-mediated mechanism-based inhibition of CYP1A2. Chem. Biol. Interact. 2015, 237, 133-140). At 10 μg/insect, cardamom produced the highest co-toxicity factor (200) seen at this dose. This oil is predominantly composed of complex mixtures of oxygenated monoterpenoids (Noumi, E.; et al. Chemical and Biological Evaluation of Essential Oils from Cardamom Species. Molecules 2018, 23).

While the results described herein show a number of synergistic plant essential oils, some apparent differences from other studies are noted. For example, Tak et al. showed that 10 μg/female doses of cedarwood, dill, and fennel oils applied in combination with permethrin did not produce statistically significant mortality greater than permethrin alone, whereas cedarwood, dillweed and dillseed, and fennel oils synergized natural pyrethrins at the specific doses studied here (Tak, J. H.; et al. Screening for Enhancement of Permethrin Toxicity by Plant Essential Oils Against Adult Females of the Yellow Fever Mosquito (Diptera: Culicidae). J. Med. Entomol. 2020, 57, 1149-1156). Without wishing to be bound by theory, the greater potential of plant essential oils to increase the toxicity of natural pyrethrins vs. permethrin may result from greater susceptibility of natural pyrethrins to metabolic degradation than permethrin. If this is the case, inhibition of metabolic processes by plant essential oils may more significantly increase the toxicity of natural pyrethrins than permethrin. Norris et al. put forth a similar justification after finding type I pyrethroids were more strongly synergized by plant essential oils than type II pyrethroids (Norris, E. J.; et al. Plant essential oils synergize various pyrethroid insecticides and antagonize malathion in Aedes aegypti. Med. Vet. Entomol. 2019, 33, 453-466).

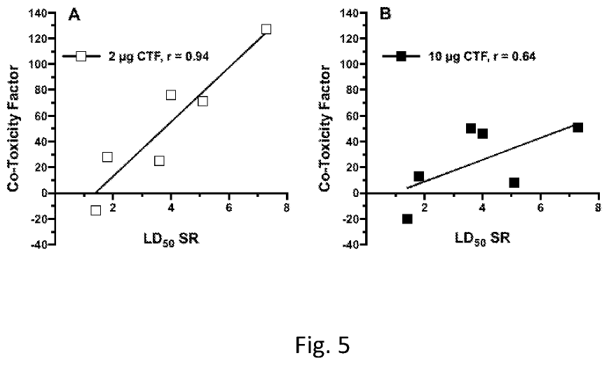

To further evaluate the co-toxicity factor method, a number of plant essential oils that produced co-toxicity factors greater than 20 (and those that produced co-toxicity factors between −20 and 20) were selected to assess whether this method translated well to the established LD₅₀ ratio method of identifying synergism. If the co-toxicity factor method is meaningful and scientifically sound, it should translate well to another metric commonly utilized to measure synergism (Jiang, S.; et al. High-throughput screening method for evaluating spatial repellency and vapour toxicity to mosquitoes. Med. Vet. Entomol. 2019, 33, 388-396; Yang, L.; et al. Pyrethroid-Derived Acids and Alcohols: Bioactivity and Synergistic Effects on Mosquito Repellency and Toxicity. J. Agric. Food Chem. 2020, 68, 3061-3070; and Yang, L.; et al. Reduced effectiveness of repellents in a pyrethroid-resistant strain of Aedes aegypti (Diptera: Culicidae) and its correlation with olfactory sensitivity. Pest. Manag. Sci. 2020, 76, 118-124). In these studies, oils that produced co-toxicity factors greater than 20 also produced significant synergism ratios, such as Amyris, cedarwood (Virginian), and cedarwood (Texas). Moreover, the two oils that did not produce additive co-toxicity factors (i.e., between −20 and 20), citronella and fir needle oil, did not produce statistically significant synergism ratios. Correlation between traditional synergism ratios and co-toxicity factors at the 2 μg/insect level was quite strong (Pearson Correlation r=0.94) (FIG. 5). For example, Amyris produced the largest synergism ratio and the largest co-toxicity factor. Direct correlation was less pronounced when comparing the synergism ratios obtained using 2 μg/insect+NP with the co-toxicity factors obtained using 10 μg/insect of oil (Pearson Correlation r=0.64). It is possible that the slope values of combined mixtures may directly affect the degree of co-toxicity factors observed at low or high potency screening concentrations, in addition to any number of toxicokinetic/dynamic factors. Differences in the ability of plant essential oils to inhibit metabolic processes or aid/hinder penetration of natural pyrethrins may also differ at each respective dose applied (2 or 10 μg). More work needs to be performed to comprehensively evaluate the strengths and weaknesses of this method, but the study presented herein supports the throughput and merit of co-toxicity metric analysis.

Insecticide synergists improve the efficacy of various synthetic and natural insecticides, potentially allowing them to overcome insecticide resistance in the field (Casida, J. E. Mixed-function oxidase involvement in the biochemistry of insecticide synergists. J. Agric. Food Chem. 1970, 18, 753-772). This study demonstrates the potential of a set of plant essential oils to selectively enhance or antagonize natural pyrethrins when both are applied in combination. Not only did some of these oils synergize natural pyrethrins-based mortality at 24 h, they also increased its ability to immobilize insects shortly after exposure (knockdown at 1 h). However, not all oils produced synergism, with many producing antagonisms of natural pyrethrins toxicity. In fact, synergism and/or antagonism appeared to be dose-dependent. This study demonstrates the utility of select plant essential oils as leads for the development of future insecticide synergists.

Efforts have been made to ensure accuracy with respect to numbers used (e.g., amounts, temperature, etc.) but some experimental errors and deviations should be accounted for.

One skilled in the art will recognize many methods and materials similar or equivalent to those described herein, which could be used in the practicing the subject matter described herein. The present disclosure is in no way limited to just the methods and materials described.

Unless defined otherwise, technical and scientific terms used herein have the same meaning as commonly understood by one of ordinary skill in the art to which this subject matter belongs, and are consistent with: Singleton et al (1994) Dictionary of Microbiology and Molecular Biology, 2nd Ed., J. Wiley & Sons, New York, NY; and Janeway, C., Travers, P., Walport, M., Shlomchik (2001) Immunobiology, 5th Ed., Garland Publishing, New York.

Throughout this specification and the claims, the words “comprise,” “comprises,” and “comprising” are used in a non-exclusive sense, except where the context requires otherwise. It is understood that embodiments described herein include “consisting of” and/or “consisting essentially of” embodiments.

Where a range of values is provided, it is understood that each intervening value, to the tenth of the unit of the lower limit, unless the context clearly dictates otherwise, between the upper and lower limit of the range and any other stated or intervening value in that stated range, is encompassed. The upper and lower limits of these small ranges which may independently be included in the smaller rangers is also encompassed, subject to any specifically excluded limit in the stated range. Where the stated range includes one or both of the limits, ranges excluding either or both of those included limits are also included.

Many modifications and other embodiments set forth herein will come to mind to one skilled in the art to which this subject matter pertains having the benefit of the teachings presented in the foregoing descriptions and the associated drawings. Therefore, it is to be understood that the subject matter is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An arthropod control composition comprising pyrethrum and a second agent selected from the group consisting of:
i. a compound of Formula I 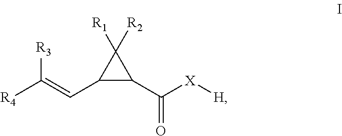
wherein,
R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
R₁ and R₂ are each independently selected from hydrogen, haloalkyl, alkenyl, alkynyl, and C₁₋C₆ alkyl; and
X is selected from the group consisting of O, NH, and S;
and
ii. an essential oil,
wherein said composition is synergistic, in admixture with a carrier.

2. The arthropod control composition of claim 1, wherein said composition is a vapor.

3. The arthropod control composition of claim 1, wherein said second agent is a compound of Formula I.

4. The arthropod control composition of claim 3, wherein X is O.

5. The arthropod control composition of claim 4, wherein R₁ and R₂ are each methyl.

6. The arthropod control composition of claim 5, wherein R₃ and R₄ are each independently selected from the group consisting of C₁₋C₃ alkyl and halo.

7. The arthropod control composition of claim 6, wherein R₃ and R₄ are each independently methyl.

8. The arthropod control composition of claim 7, wherein said compound of Formula I is

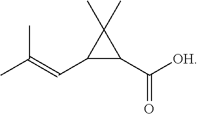

9. The arthropod control composition of claim 1, wherein,
said second agent is a compound of Formula I, wherein said compound is 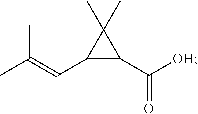
said pyrethrum is present in said arthropod control composition at a concentration of about 0.01 μg/cm² to about 10,000 μg/cm²; and
said second agent is present in said arthropod control composition at a concentration of about 0.1 μg/cm² to about 1,000 μg/cm².

10. The arthropod control composition of claim 6, wherein R₃ and R₄ are each independently chloro.

11. The arthropod control composition of claim 10, wherein said compound of Formula I is

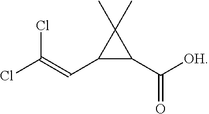

12. The arthropod control composition of claim 1, wherein,
said second agent is a compound of Formula I, wherein said compound is 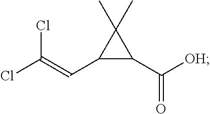
said pyrethrum is present in said arthropod control composition at a concentration of about 0.01 μg/cm² to about 10,000 μg/cm²; and,
said second agent is present in said arthropod control composition at a concentration of about 0.5 μg/cm² to about 5,000 μg/cm².

13. The arthropod control composition of claim 1, wherein said composition is a solution, dust, granular formulation, or emulsion.

14. The arthropod control composition of claim 1, wherein said second agent is an essential oil.

15. The arthropod control composition of claim 14, wherein said essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil.

16. The arthropod control composition of claim 15, wherein said essential oil is selected from the group consisting of citronella oil, geranium oil, and Amyris oil.

17. The arthropod control composition of claim 16, wherein said essential oil is citronella oil.

18. The arthropod control composition of claim 1, wherein,
said second agent is an essential oil, wherein said essential oil is selected from the group consisting of citronella oil, geranium oil, and Amyris oil;
said pyrethrum is present in said arthropod control composition at a concentration of about 0.01 μg/cm² to about 10,000 μg/cm²; and,
said essential oil is present in said arthropod control composition at a concentration of about 1 μg/cm² to about 10,000 μg/cm².

19. The arthropod control composition of claim 15, wherein said essential oil is selected from the group consisting of Cedarwood Virginian, dill seed oil, fennel oil, fir needle oil, and parsley, wherein said essential oil is present in said arthropod control composition at a concentration of about 2 μg/insect.

20. The arthropod control composition of claim 15, wherein said essential oil is selected from the group consisting of Amyris oil, Balsam Copaiba, Cedarwood Texas, Cedarwood Virginian, dill seed oil, fennel oil, fir needle oil, and Nutmeg EI, wherein said essential oil is present in said arthropod control composition at a concentration of about 2 μg/insect.

21. The arthropod control composition of claim 15, wherein said essential oil is selected from the group consisting of cade oil, cardamom, Cedarwood Virginian, cypress, dill weed oil, fir needle oil, guaiacwood, wherein said essential oil is present in said arthropod control composition at a concentration of about 100 μg/insect.

22. The arthropod control composition of claim 15, wherein said essential oil is selected from the group consisting of Amyris oil, Balsam Copaiba, Cardamom, cedarleaf, Cedarwood Texas, Cedarwood Virginian, Cypress, dill seed oil, dill weed, fennel oil, ginger root, nutmeg EI, and parsley, wherein said essential oil is present in said arthropod control composition at a concentration of about 100 μg/insect.

23. The arthropod control composition of any one of claims 19-22, wherein said pyrethrum is present in said arthropod control composition at a concentration of about 0.55 ng/mg insect.

24. The arthropod control composition of claim 1, wherein said composition is capable of causing knockdown of an arthropod within one hour of exposure to said composition.

25. The arthropod control composition of claim 1, wherein said composition is capable of causing mortality to an arthropod within twenty-four hours of exposure to said composition.

26. A method of providing a composition in an arthropod repellent medium from which a vaporized composition can be dispersed, wherein said composition comprises pyrethrum and a second agent selected from the group consisting of:
i. a compound of Formula I 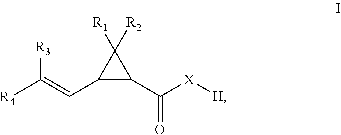
wherein,
R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
R₁ and R₂ are each independently selected from hydrogen, haloalkyl, alkenyl, alkynyl, and C₁₋C₆ alkyl; and
X is selected from the group consisting of O, NH, and S;
and
ii. an essential oil,
wherein said composition is synergistic, in admixture with a carrier.

27. A method of repelling an arthropod from an object or locus, comprising contacting said object or locus with a composition comprising pyrethrum and a second agent selected from the group consisting of:
i. a compound of Formula I 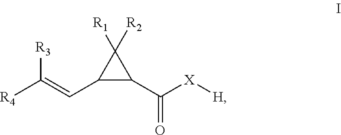
wherein,
R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
R₁ and R₂ are each independently selected from hydrogen, haloalkyl, alkenyl, alkynyl, and C₁₋C₆ alkyl; and
X is selected from the group consisting of O, NH, and S;
and
ii. an essential oil,
wherein,
said composition is synergistic, in admixture with a carrier; and,
said arthropod is repelled from an adjacent area to said object or locus and is not physically contacted with said object or locus.

28. The method of claim 27, wherein said arthropod is a fly, spider, butterfly, moth, crab, mosquito, centipede, tick, millipede, biting midge, bedbug, kissing bug, Varroa mite, dust mite, or scorpion.

29. The method of claim 28, wherein said arthropod is a mosquito.

30. The method of claim 27, where said object or locus is an area, an environment, or the skin of an animal.

31. The method of claim 27, wherein said second agent is a compound of Formula I.

32. The method of claim 31, wherein X is O.

33. The method of claim 32, wherein R₁ and R₂ are each methyl.

34. The method of claim 33, wherein R₃ and R₄ are each independently selected from the group consisting of C₁₋C₃ alkyl and halo.

35. The method of claim 34, wherein R₃ and R₄ are each independently methyl.

36. The method of claim 35, wherein said compound of Formula I is

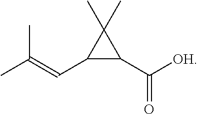

37. The method of claim 27, wherein,
said second agent is a compound of Formula I, wherein said compound is 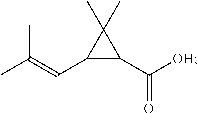
said pyrethrum is present in said composition at a concentration of about 0.01 μg/cm² to about 10,000 μg/cm²; and
said second agent is present in said composition at a concentration of about 0.1 μg/cm² to about 1,000 μg/cm².

38. The method of claim 34, wherein R₃ and R₄ are each independently chloro.

39. The method of claim 38, wherein said compound of Formula I is

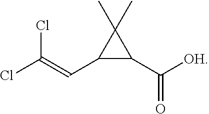

40. The method of claim 27, wherein,
said second agent is a compound of Formula I, wherein said compound is 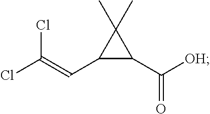
said pyrethrum is present in said composition at a concentration of about 0.01 μg/cm² to about 10,000 μg/cm²; and,
said second agent is present in said composition at a concentration of about 0.5 μg/cm² to about 5,000 μg/cm².

41. The method of claim 27, wherein said second agent is an essential oil.

42. The method of claim 41, wherein said essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil.

43. The method of claim 42, wherein said essential oil is selected from the group consisting of citronella oil, geranium oil, and Amyris oil.

44. The method of claim 43, wherein said essential oil is citronella oil.

45. The method claim 27, wherein,
said second agent is an essential oil, wherein said essential oil is selected from the group consisting of citronella oil, geranium oil, and Amyris oil;
said pyrethrum is present in said composition at a concentration of about 0.01 μg/cm² to about 10,000 μg/cm²; and,
said essential oil is present in said composition at a concentration of about 1 μg/cm² to about 10,000 μg/cm².

46. The method of claim 27, wherein said composition is formulated for use in a vaporizer, evaporator, fan, heat, candle, or wicked apparatus.

47. The method of claim 27, wherein said composition is a vapor.

48. A method for controlling one or more arthropods, comprising contacting an object or locus adjacent to said one or more arthropods with a composition comprising pyrethrum and a second agent selected from the group consisting of:
i. a compound of Formula I 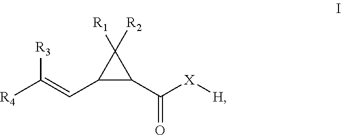
wherein,
R₄ and R₃ are each independently selected from the group consisting of hydrogen, halo, haloalkyl, C₅₋C₁₂ heteroaryl, haloaryl, C₆₋C₁₀ aryl, alkenyl, alkynyl, and C₁₋C₆ alkyl; or,
R₃ and R₄ are taken together with the carbon to which they are attached to form a C₅₋C₁₂ heteroaryl, C₆₋C₁₀ aryl, C₃₋C₁₂ cycloalkyl, haloaryl, or C₃₋C₁₂ heterocycloalkyl;
R₁ and R₂ are each independently selected from hydrogen, haloalkyl, alkenyl, alkynyl, and C₁₋C₆ alkyl; and
X is selected from the group consisting of O, NH, and S;
and
ii. an essential oil,
wherein,
said composition is synergistic, in admixture with a carrier; and,
wherein said one or more arthropods are not physically contacted with said object or locus.

49. The method of claim 48, wherein said one are more arthropods are flies, spiders, butterflies, moths, crabs, mosquitoes, centipedes, ticks, millipedes, biting midges, bedbugs, kissing bugs, Varroa mites, dust mites, or scorpions.

50. The method of claim 49, wherein said one or more arthropods are mosquitoes.

51. The method of claim 48, where said object or locus is an area, an environment, or the skin of an animal.

52. The method of claim 48, wherein said second agent is a compound of Formula I.

53. The method of claim 52, wherein X is O.

54. The method of claim 53, wherein R₁ and R₂ are each methyl.

55. The method of claim 54, wherein R₃ and R₄ are each independently selected from the group consisting of C₁₋C₃ alkyl and halo.

56. The method of claim 55, wherein R₃ and R₄ are each independently methyl.

57. The method of claim 48, wherein said compound of Formula I is

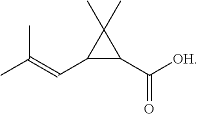

58. The method of claim 48, wherein,
said second agent is a compound of Formula I, wherein said compound is 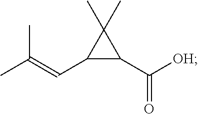
said pyrethrum is present in said composition at a concentration of about 0.01 μg/cm² to about 10,000 μg/cm²; and
said second agent is present in said composition at a concentration of about 0.1 μg/cm² to about 1,000 μg/cm².

59. The method of claim 55, wherein R₃ and R₄ are each independently chloro.

60. The method of claim 59, wherein said compound of Formula I is

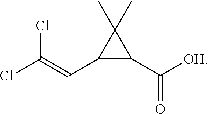

61. The method of claim 48, wherein,
said second agent is a compound of Formula I, wherein said compound is 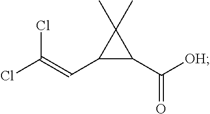
said pyrethrum is present in said composition at a concentration of about 0.01 μg/cm² to about 10,000 μg/cm²; and,
said second agent is present in said composition at a concentration of about 0.5 μg/cm² to about 5,000 μg/cm².

62. The method of claim 48, wherein said second agent is an essential oil.

63. The method of claim 62, wherein said essential oil is selected from the group consisting of citronella oil, Amyris oil, Balsam Peru, cardamom, Cedarwood Texas, Cedarwood Virginian, dill seed oil, ginger root, galbanum oil, cade oil, ginger root oil, guaiacwood, fir needle oil, guaiacwood oil, cypress oil, cinnamon bark oil, patchouli oil, cedarleaf oil, peppermint oil, lemongrass oil, orange oil, lavender oil, rosemary oil, cedarwood oil, lemon Eucalyptus oil, catnip oil, geranium oil, castor oil, clove bud oil, soybean oil, basil oil, neem oil, vetiver oil, Canadian balsam Fir, nutmeg oil, nutmeg EI, fennel oil, dill weed oil, balsam copaiba, parsley, and tea tree oil.

64. The method of claim 63, wherein said essential oil is selected from the group consisting of citronella oil, geranium oil, and Amyris oil.

65. The method of claim 64, wherein said essential oil is citronella oil.

66. The method claim 48, wherein,
said second agent is an essential oil, wherein said essential oil is selected from the group consisting of citronella oil, geranium oil, and Amyris oil;
said pyrethrum is present in said composition at a concentration of about 0.01 μg/cm² to about 10,000 μg/cm²; and,
said essential oil is present in said composition at a concentration of about 1 μg/cm² to about 10,000 μg/cm².

67. The method of claim 48, wherein said composition is formulated for use in a vaporizer, evaporator, fan, heat, candle, or wicked apparatus.

68. The method of claim 48, wherein said composition is a vapor.

69. A method of repelling a species of arthropod from a locus, comprising contacting on said locus the arthropod control composition of any one of claims 1-23.

70. A method for controlling one or more arthropods, comprising contacting said one or more arthropods with the arthropod control composition of any one of claims 1-23.

71. The method of claim 70, wherein said one or more arthropods experiences knockdown within one hour of exposure to said composition.

72. The method of claim 70, wherein said one or more arthropods reaches its mortality within twenty-four hours of exposure to said composition.

73. The arthropod control composition of claim 1, or method of claim 26, 27, 48, 69, or 70, wherein said pyrethrum is present at a concentration of about 0.01 μg/cm² to about 10,000 μg/cm², and said second agent is present at a concentration of about 0.01 μg/cm² to about 50,000 μg/cm².
